(19) United States
(12) Patent Application Publication
(10) Pub. No.: US 2016/0132800 A1
(43) Pub. Date: May 12, 2016

(54) Business Relationship Accessing

(71) Applicant: 0934781 B.C. Ltd, Vancouver (CA)

(72) Inventors: Ali DAVAR, Vancouver (CA); Simon James HEWITT, Vancouver (CA); David Robert THOMPSON, Vancouver (CA)

(73) Assignee: 0934781 B.C. LTD, Vancouver (CA)

(21) Appl. No.: 14/946,082

(22) Filed: Nov. 19, 2015

Related U.S. Application Data
(63) Continuation-in-part of application No. 14/537,092, filed on Nov. 10, 2014.

(51) Int. Cl. G06Q 10/06

(52) U.S. Cl. CPC G06Q 10/0637

(57) ABSTRACT

A computer method and system provide means for inputting, verifying and outputting business relationship data to a user. The system comprises a database of business relationships between organizations, some of which are marked as visible or hidden. The system applies an algorithm to determine which relationships to verify. A user may search for an organization according to search criteria and the system will select a set of organizations that match the criteria. Web content is displayed based on the verification and visibility status of the relationships.

### BACKGROUND

Business typically requires a multitude of businesses to work together, wherein there are many involved in a supply chain, many acting as service providers, advisors, brokers and of course customers to pay for it all. To be successful, a business is required to identify and assemble a network appropriate to service the business at each point. In many cases an organization will have an established network; however, there is commonly a need for an organization to locate a new supplier, partner, client, or buyer. These can be easily found with reference to an Internet search engine or phone directory. Dedicated websites currently exist to provide a user with a list of businesses according to a particular industry or service/product offered.

However, this does not help the searcher determine which potential supplier/client is the best or most relevant to themselves. By human nature it is common to ask who is used and trusted by other businesses that are respected by the searcher.

This information is usually only known to those with years of experience, are well connected or who have access to specialist business directories. In some cases relationships can be determined from online or physical records but it is not always possible to know the nature, trust, strength, or present activity of the relationship. The search is typically made against some criteria such as location or sector. Even with knowledge of these relationships, it is not a simple matter to search by certain criteria, filter certain categories or weigh large amounts of such data.

Existing platforms attempt to solve this problem by creating searchable directories of businesses and/or providing reviews from other users. In some instances, the list is ranked according to a metric such as size or revenue. In these cases the user must judge what review or metric might be suitable for their own business. Most recently, classes of programs called Recommendation Systems look for similarity between users to recommend products and services.

Additionally a business may wish to publicize its relationships with other businesses. This may be accomplished using news releases, public relations firms, or listings on their websites. This may require permission of the connected company. There may be some relationships that either company to the relationship is not comfortable revealing, or at least not using their own name. In this case, there is no way for the vendor or client to demonstrate their relevance in a certain sector and a business searching for an appropriate vendor or client will not be able to determine their relevance.

### BRIEF SUMMARY OF THE INVENTION

The inventors have envisaged a database, network, system, and methods for operating with data about business relationships.

According to one innovative aspect, certain exemplary embodiments provide a computer-implemented method for verifying data input to a database identifying business relationships between organizations. The method including: receiving data from a user associated with a first organization, the data defining a business relationship between the first organization and a second organization; storing said relationship data; selecting and implementing one or more verification schemes; determining whether the selected verification schemes verified the relationship data; and updating a relationship confirmation score or status accordingly.

The steps of selecting and implementing a verification scheme are contingent upon the relationship being selected according to a sampling algorithm.

The method may further include selecting another of the verification schemes if the relationship confirmation score remains below a threshold or the relationship confirmation status remains unverified.

One of the verification schemes may includes: communicating, over a network, a verification URL to a second user associated with the second organization, wherein following the URL provides means for the second user to verify the relationship data; and authenticating whether the verification response originated from a user associated with the second organization.

One of the verification schemes may include using a web crawler to search for identity data of first and second organizations in a single web content, such as a website (a) relevant to at least one of said organizations, (b) associated with an industry of at least one of said organizations or (c) selected from a set of authenticated websites.

One of the verification schemes may include communicating with an authenticated third-party database, accessed by the first organization, to verify the relationship data in that third-party database.

One of the verification schemes may include providing means for a second user associated with the second organization to log in to an account on the web service and enter their confirmation or rejection of the relationship data.

One of the verification scheme may includes receiving a URL from the first user and then crawling the webpage at the URL for data confirming the relationship.

The method may further include providing an interface to the first user to mark the second organization as hidden or visible and then setting a status in the relationship record as such.

The selection of verification scheme(s) may depend on success of verification schemes previously selected for the first organization.

The selection of verification scheme(s) may depend on a trust score associated with the first user or first organization.

The method may further include initializing the relationship confidence score with a score that depends on a trust score associated with the first user or first organization.

The method may further include increasing a trust score of the first organization, if the relationship data is verified by the selected verification scheme.

According to another innovative aspect, certain exemplary embodiments provide a computer-implemented method for accessing a database identifying business relationships between organizations. The method includes: receiving, at a webserver, a request for certain web content from a client computing device; querying the database to identify business relationships satisfying said request; for each identified relationship, retrieving an associated relationship confirmation score or confirmation status, indicating whether the relationship's data has been confirmed; preparing web content using only relationships associated with a confirmation score above a threshold score or a confirmation status of TRUE; and serializing and communicating said web content to the client computing device.

Preparing said web content may include aggregating the attribute data of client organizations associated with the identified relationships across a plurality of attribute values and selecting some of the aggregated attribute values, using only relationships associated with a confirmation score above a threshold score or a confirmation status of TRUE.

Preparing said web content may include computing recommendation metrics for vendor organizations using only relationship associated with a confirmation score above a threshold score or a confirmation status of TRUE.

According to another innovative aspect, certain exemplary embodiments provide a computer-implemented method including: providing a database of organization objects connected by relationship objects, some of which relationships are unverified; one or more processors receiving a request from a user to send a message to a vendor in the database; the one or more processors retrieving, from the database, attributes of at least one unverified relationship of the vendor; the one or more processors creating a text statement including the attributes of the unverified relationship; the one or more processors including the text statement in the message; the one or more processors receiving a response message from the vendor; the one or more processors analyzing the response message to determine whether the message corroborates the unverified relationship; and the one or more processors updating a confirmation status or score of the unverified relationship depending on the corroboration.

The at least one unverified relationship may be selected based on relevance of attributes of the relationship or associated client to the user's organization's attributes or to the user's search query

The method may further include determining whether the response includes data that verify the relationship and amending a confirmation status of the relationship in the database accordingly.

According to another innovative aspect, certain exemplary embodiments provide a computer-implemented method for accessing a database storing business relationships between organizations. The method includes: receiving, at a webserver, a request for web content from a client computing device; querying the database to identify business relationships between first and second organizations matching said request; for each identified relationship, determining whether the second organization is marked as hidden or visible; preparing web content using identity data and attribute data of second organizations marked as visible, and attribute data but not identification data for second organizations marked as hidden; and serializing and communicating said web content to the client computing device.

Preparing said web content may include aggregating the attribute data of second organizations across a plurality of attribute values and selecting some of the aggregated attribute values.

The web content to be serialized may include identity data for one or more first organizations

Attribute data may include business descriptors for organizations but not data identifying organizations.

The attribute data may include at least one of: business sector, industry, market capitalization, city, number of employees, and revenue.

The request may includes criteria for selecting relationship records using attribute data or identification data of first organizations or attribute data of relationships.

The method may further include populating the database by receiving data defining a business relationship between a first organization and a second organization, wherein the data includes whether the second organization is to be hidden or visible and storing said relationship data in the database.

The method may further include creating nodes in the database corresponding to the two organizations.

The method may further include storing the relationship data as a relationship edge in the database between nodes of the first and second organizations, the edge including a flag/status to mark said second organization as hidden or visible.

The edge may be directional and store the direction of goods or services from the first organization to the second organization.

According to another innovative aspect, certain exemplary embodiments provide a computer-implemented method including: receiving, at a server, from a user associated with a first organization, relationship data defining a business relationship between the first organization and a second organization, and visibility data indicating whether the identity of the second organization is intended to be visible or hidden from other users; creating a data object in the database including the relationship data and visibility data and linking the first and second organizations

According to another innovative aspect, certain exemplary embodiments provide a computer-implemented method including: receiving a request to display clients of a vendor organization; providing a database of organization data objects connected by relationship data objects, each relationship data object having a visibility status indicating whether a client organization is hidden or visible to users; identifying client organizations and their visibility status from relationship data objects connected to the vendor; and displaying identity data of clients to a user only if a) the visibility status is TRUE or b) the visibility status is CONDITIONAL and a conditional requirement is met by the user or the user's organization.

The method may display attribute data, but not identification data, of clients if the visibility status is FALSE or the condition requirements are not met;

The condition requirements may be met if the user is associated with an organization in the database having attribute sufficiently similar to attributes of the hidden client.

The method may log URL requests from a user to quantify a user's interaction to determine that the conditional requirements are met.

It is therefore possible to create an extensive network of relationships to capture the inter-workings of organizations and give them credit for their expertise and also make them searchable by a variety of criteria to return meaningful data even where certain organizations are hidden or relationships unverified.

### BRIEF DESCRIPTION OF THE DRAWINGS

FIG. 1 illustrates a diagram of a network of computers for accessing a database of business relationships.

FIG. 2 is a diagram of agents for interaction between a client device and server.

FIG. 3 is a diagram of example relationships in a database.

FIG. 4 is a diagram of a database structure for relationships and organizations.

FIG. 5 is a display of relationship data for a particular organization.

FIG. 6 is a display of relationship data for a search result.

FIG. 7 is a diagram of a process of selecting vendors starting from peers of a searching entity.

FIG. 8 is a diagram of a process of selecting vendors starting from vendors matching certain search criteria.

FIG. 9A is a diagram of a database graph structure.

FIG. 9B is a diagram of a graph structure showing connections relevant to a search and their weightings.

FIG. 10 is a flow diagram of data flow and connections between software agents to output a set of vendors.

FIG. 11 is a flowchart of a process for outputting data for anonymous clients.

FIG. 12 is a flowchart of a process for verifying new relationships.

FIG. 13 is a chart of trust score and relationships for an example company.

FIG. 14A is a portion of a database having a verified status.

FIG. 14B is an email template to testing unverified data.

FIG. 15 is a flow chart of a verification process.

FIG. 16 is a UI for receiving relationship and visibility data.

### DETAILED DESCRIPTION

A system, network, and computer program are implemented to capture the relationships between organizations. This enables users as viewers to determine the relationships between organizations or search for an organization according to certain criteria. This also enables users as content creators to demonstrate their place and associations in the business community for viewers to analyze.

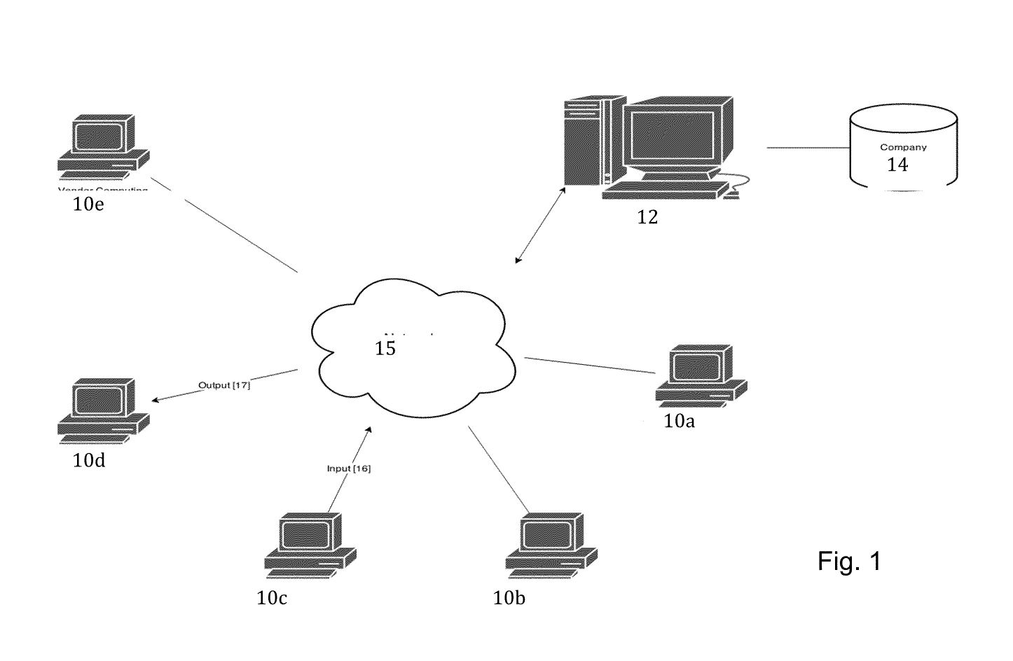

As shown in FIG. 1, the system may be implemented as a network 15 of interconnected computing devices 10a-e and server 12 for inputting and receiving relationship data from a database 14. The database may be a document store, relational database or graph database. Those skilled in the art of computer science will know how to implement such a database and will appreciate that there are other data structures that may be appropriate. The database 14 is connectable to user 10c for receiving data and user 10d for outputting data. The names of these devices are for simplicity of understanding and may be any computing device and each device may be used for a plurality of these roles.

The server 12 may include one or more processors for reading instructions from computer-readable storage media and executing the instructions to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving goods or services. While an organization may typically be a business, the term includes but is not limited to charities, corporations, sole proprietors, Non-Government Organizations, institutions, government departments, and partnerships. A business relationship is generally used herein to refer to commercial transactions between organizations to provide those goods or services. Preferably the relationship represents an agreement, which, for example, may subsist in a contract, a terms-of-business document or an ongoing understanding. Most preferably the business relationships stored in the database represent relationships that have been ongoing for at least three months or have at least three repeat instances of transactions. This is in contrast to personal relationships, non-commercial relationships, click-thru data or user website activity data, or one-off commercial transactions. Therefore the strength of the present recommendation is derived from a deep tie between organizations, as recorded in the database. An ongoing, high-value relationship is used as a proxy to suggest that one organization is a worthy supplier of goods or services.

A user is generally defined as a person who interacts with a computer, typically entering search criteria, following hyperlinks and viewing results to determine what organizations are recommended. The user is expected to be associated with a particular organization and is seeking a recommendation suited for that organization. A buyer-user is someone associated with an organization looking to buy products or services. A vendor-user is someone associated with an organization supplying products or services.

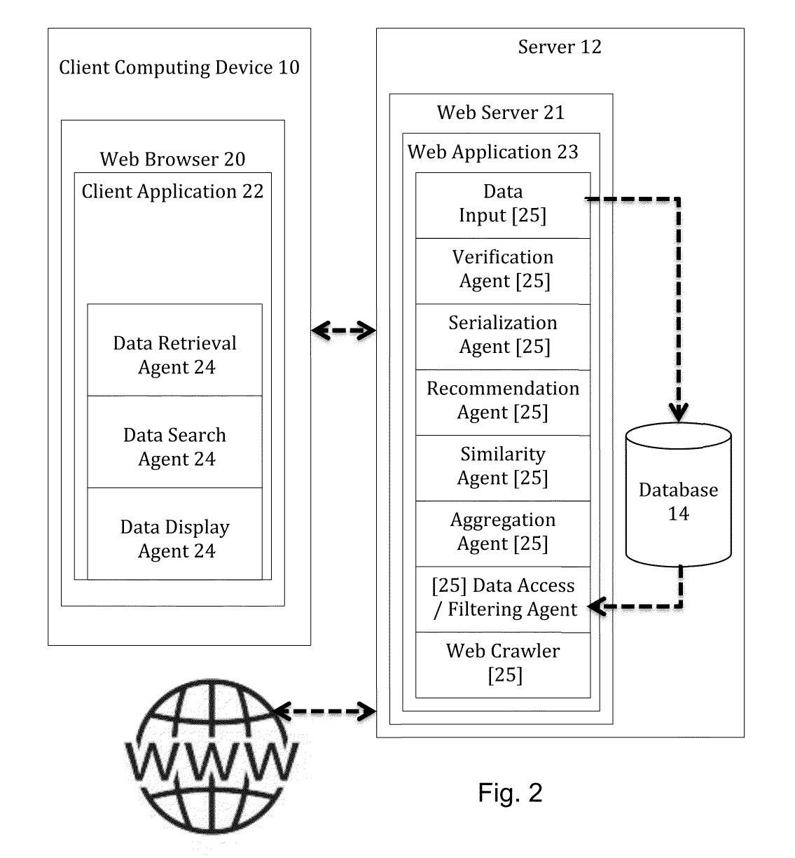

FIG. 2 illustrates the interaction between a client computation device 10 and the server 12 over network 15. The device 10 may interact via a web browser 20 having an application layer 22. The application may use software agents 24 to search the database 14-retrieve output data 17 and display the data on the user's device. The server 12 may be a reverse proxy server for an internal network, such that the client 10 communicates with an Nginx web server 21, which relays the client's request to associated server(s) and database(s) 14. Within the server(s) a web application 23 includes agents 25 for operating with the database 14.

Users may access the database 14 remotely using a desktop or laptop computer, smartphone, tablet, or other client computing device 10 connectable to the server 12 by mobile internet, fixed wireless internet, WiFi, wide area network, broadband, telephone connection, cable modem, fibre optic network or other known and future communication technology.

The client device 10 may interact with the server using a web browser using conventional Internet protocols. The web server will use the serialization agent to convert the raw data into a format requested by the browser. Some or all of the methods for operating the database may reside on the server device. The client device 10 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device.

The methods and database discussed herein may be provided on a variety of computer system and are not inherently related to a particular computer apparatus, particular programming language, or particular database structure. In preferred embodiments the system is implemented on a server. The term ‘server’ as used herein refers to a system capable of storing data remotely from a user, processing data and providing access to a user across a network. The server may be a stand-alone computer, mainframe, a distributed network or part of a cloud-based server.

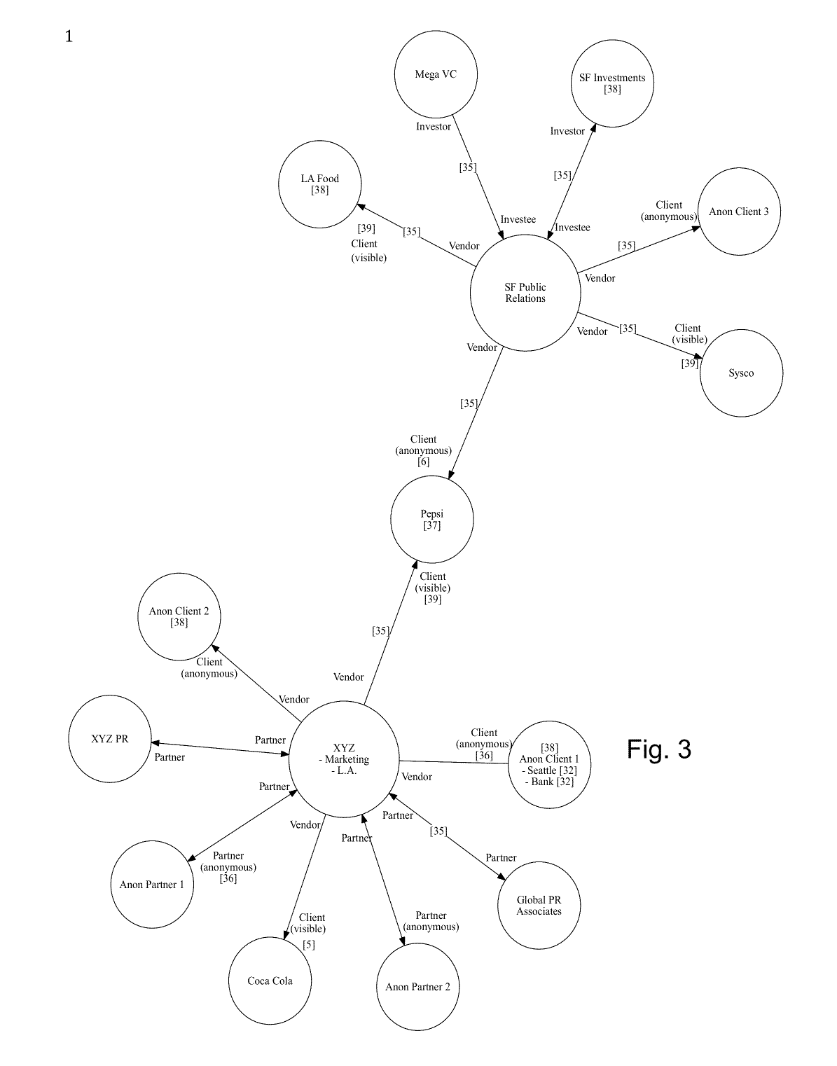

As conceptualized in FIG. 3, the database is structured to record a plurality of relationships 35 with data about the relationships such as the nature of the relationship, attributes 32 about the organizations 38, and identification data (such as a name). A code may be used in the database to indicate that a party is a visible party 39 or an anonymous party 36.

There may be only one relationship recorded for an organization but in most cases there will be many. The database preferably includes millions of organizations and relationships.

The nature of the relationship may be displayed textually or graphically. The direction is indicated graphically in FIG. 3 using an arrow from the supplier of goods or services to the receiver.

As shown in this example, fifteen nodes 38 representing organizations are interconnected via fourteen relationships 35, indicating which organization in the relationship is a client, vendor, investor, partner, etc. When displaying ‘XYZ's’ profile, four parties will be identified and four parties will be hidden. In the case of ‘Anon Client 1’, the attribute data ‘Seattle’ and Bank may be displayed instead of the party name. As indicated, the ‘Hewitt Corp’ node is marked as visible in the relationship with ‘XYZ’ but anonymous in the relationship with ‘SF Public Relations’.

Certain existing social networks allow the user to take part whilst remaining anonymous themselves. For example, Quora users can ask or answer questions anonymously and LinkedIn users can view profiles anonymously. In the presently described system, the user will be known to other users, however, they may want to have their associates remain anonymous. Thus compared to known networking sites, the user entering their relationships is visible but the connected organization may be hidden to viewers.

In contrast to certain social networks, where users may assume pseudonyms and are free to enter fictional data about themselves or others, it is preferred that the present database contain only real parties, their real attributes and their actual relationships. Thus the present system provides methods for authenticating data as well as the users entering the data. In one embodiment, newly entered data is stored in a separate database not visible to viewers. In another embodiment newly entered data is stored in the main database but is marked as ‘unverified’. Immediately or at a later time, a program searches reputable records or websites to corroborate the data. The program may be a web crawler or web scraper. The website may be the official website of one of the parties to the relationship. The reputable record may be a government registry.

In contrast to other social networks storing mutual, non-directional connections (friend-friend, associate-associate, classmate-classmate), the present database and system are arranged to record the nature of relationships and their direction, for example, as indicated by the flow of goods and services from a first organization to a second organization. For example the direction may be unidirectional in the case of buyer-seller or bidirectional in the case of a partnership. This creates added complexity to the database but provides more information to viewers and creates additional search criteria.

For example, two banks may be peers to a user's organization that is looking for legal services, but the bank that receives legal advice from a law firm is more relevant than the bank that provides financial services to that law firm.

By way of example, the nature of the relationship may be described in general terms: vendor-client, provider-receiver, buyer-seller; or

in specific terms: partners, client-advisor, manufacturer-assembler, designer-distributor-retailer, joint venture, client-service provider, investor-investee, and parent-subsidiary.

Alternative terms will occur to the skilled person as appropriate descriptions of a business relationship.

A relationship record may include relationship attribute data giving further details such as the good and services, time frames involved, investment amount, product type, sales amount, or terms of the contract. For example, “XYZ has sold reagents to NY Biotech Ltd since 2008, on a non-exclusive basis”. This relationship attribute data provides the user with in-depth understanding of how each organization operates in the business community.

The system may be operated as a social network or online community wherein numerous users input numerous relationships between numerous companies. This allows users to share information with other users. Such sharing on social networks has been found to encourage the newly connected parties to become users themselves and input their own relationships with existing users or potential users, such that the total number of records expands exponentially.

### Database Format

The database may be implemented in a variety of ways known within computing science, such as a document store, object database, relational database or a graph database. Depending on the schema used the data about an organization may be called an object, a record or a node. Generally these may all be called a ‘data collection’ to capture the concept of a group of data elements associated with an organization without reference to a specific data schema.

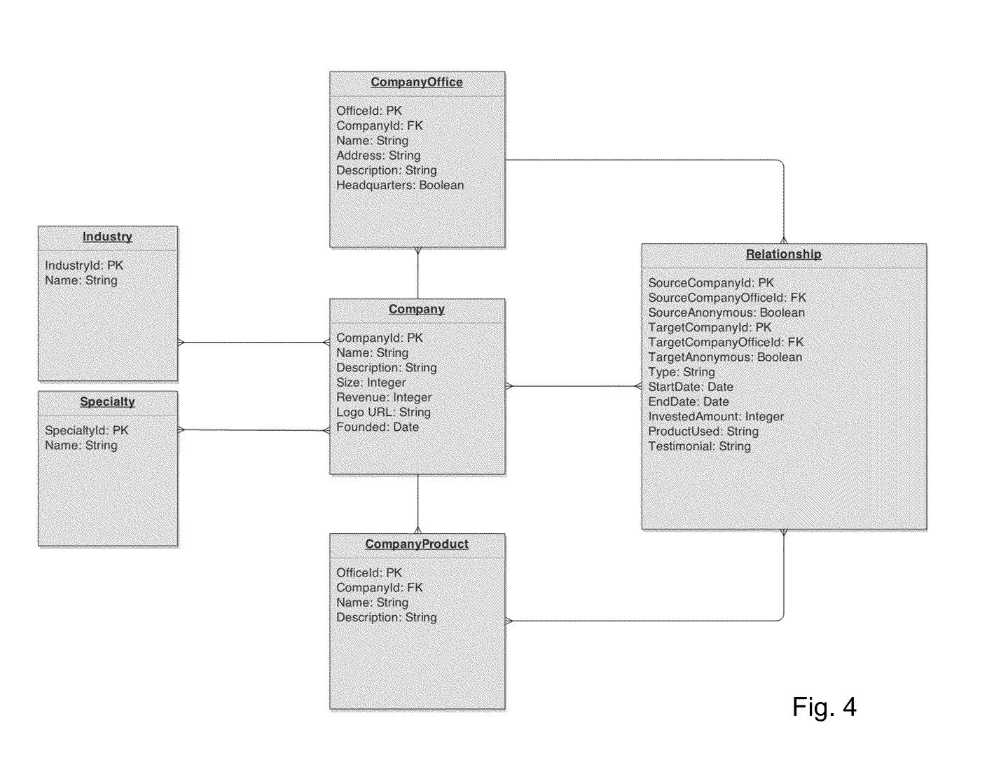

In preferred embodiments, a graph database is used, wherein organizations are stored as nodes and business relationships are stored as edges. This is illustrated in FIGS. 3 and 4 by solid lines between organization circles with arrows to indicate the direction of the flow of goods or services from a vendor to a client.

The graph may include a second type of edge (similarity edge), which records the degree to which one is similar to another. The similarity edge may be non-directional or bidirectional to indicate that two organizations are mutual peers or the peer edge may be unidirectional to indicate that one organization is considered a peer of another organization but not vice versa, or at least not in the same way or degree. There may be more than one similarity edge between organizations to capture the different degrees or ways that two organizations are similarity.

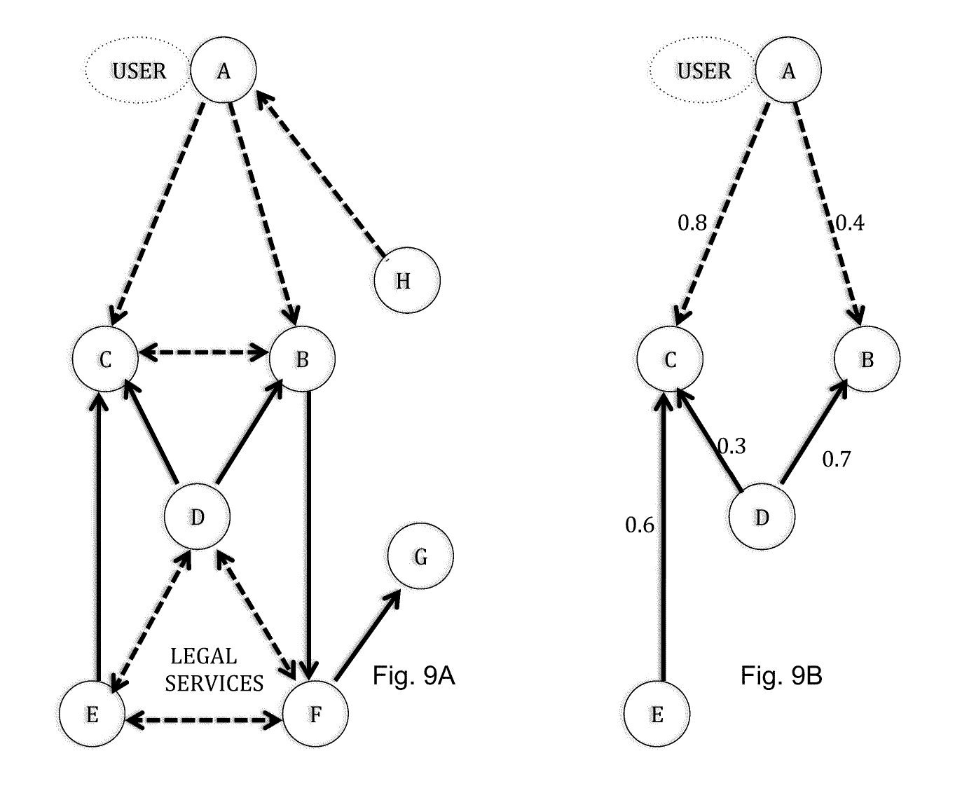

FIG. 9 illustrates a small portion of an example graph, focusing on the nodes and edges between a user's organization node (A) and vendor nodes (D, E, F) being sought. USER is associated with organization A. Solid arrows indicate relationship edges as the flow of services from a vendor node towards a client node. Dashed arrows indicate similarity edges from one organization towards an organization recorded as similar. Thus D, E and F are mutual peers and are, in this case, the target of the search. Nodes C and B are similar and both are similar to A. Node and edge values are shown separately in FIG. 9B.

FIG. 4 shows a database arranged as a number of tables such as a table of relationship records, a table of companies, a table of industries, a table of company products, a table of specialties, and a table of company offices. Other tables may be added providing additional information linkable to the other tables. The tables may contain references to other tables for the purpose of building a complete relationship or profile, without having to replicate all data in every relationship.

For example, a relationship data object includes references to each organization and data about the relationship, including whether either organization is recorded as hidden or visible when users view that relationship. An organization's identification data may be stored in the organization data object, being visible for one relationship but hidden for another.

Data about the source and target companies are stored in another table and further attributes may be stored in further tables linked to records in the company table.

Thus a complete relationship can be determined by collating data from relationship records, associated company records and associated attribute records.

In one embodiment, a relationship is assembled for output by searching the relationship table for a value (e.g. company name or relationship attribute) in one or more fields. When a matching relationship record is found, a first organization code is used to locate that organization in the company table, and a second organization code is used to locate that organization in the company table.

FIG. 4 illustrates an example relational data scheme showing the connections between tables, fields of each record in each table and data type for each field. The complete relationship to output is an assembly of data from the connected records.

In this example, there are additional tables storing data about industries (e.g. banking, manufacturing, food), specialties (investment banking, injection moulding, weddings) and products (e.g. stock transaction, toys, cakes). Such tables store data such as names of each industry and hierarchies between them.

In an alternative data scheme, complete relationships are stored as a table where each relationship data object includes fields for the first and second organization, the nature of the relationship and attribute data for each organization. This allows a relationship to be contained in a single record without the need for pointers to other tables but does require redundant storing of organization attribute data for each record.

### Data Source

The system's data input agent provide one or more ways to input a business relationship to the database, such as a website form, receiving a data file, an API callable by third-party software, and a web crawler. Preferably the relationship is input by a user working on behalf of one of the organizations (asserting organization) and includes details about the relationship and the other organization (unverified organization). In one embodiment, a web crawler scours the webpages of organizations and/or news websites to find relationships between organizations, in which case both organizations are unverified.

In a preferred embodiment, a user inputs the relationship data. The user registers and account with the present system on behalf of their organization. The user's email domain, LinkedIn account, or Customer Relationship Management software can be used to authenticate the association of the user with the organization.

Preferably the user inputs the relationship details into a user-interface provided by the web server. The interface provides for an option to mark the other organization as ‘anonymous’, i.e. to be hidden from other users. Equivalently the user selects the organization's ‘visibility’ to other users. This status is stored as a flag or status in the relationship data object.

The system stores data for organizations in the database, which can be used to find or compare organizations depending on the nature of the data. The data may be conceptually divided into different categories:

Identification data that enable the system to identify the organization. Identification data includes data such as legal name, parent company name, CEO's name, office address, IP address, logos, brand names, or company registration number;

Profile information about the organization history, expertise, and accomplishments, possibly in an unstructured text format;

Attribute data that describe properties of the organization using categories or values, but do not identify the organization. The attribute data may be sorted and classified according to a structure with defined terms. Attribute data includes classes and values such as industry, sector, general location, specialization, product class, service class, number of employees, market capitalization, field of practice, or revenue; and

Organization type data is a subset of attribute data for describing the function of an organization and includes classes such as industry, sector, specialization, product class, service class, or field of practice.

### Similarity

The personalization of the recommendation is based on determining what organizations are connected in a relevant way to peers of a user's organization. It is possible that some peers to one organization are not peers to all other members of that peer group or they may have additional peers not in that peer group. An organization that provides two distinct services will have two sets of peers, whereby members of each set may not consider the other set to be in their own peer group. Alternatively a similarity metric may be calculated between every organization in the database. This is computationally expensive and so this calculation is preferably processed offline and stored in the database. Preferably the processor only records similarity edges that are greater than a threshold similarity, so as to reduce the need to store data for minimally similar organizations.

In some cases, the user's organization will not have been recorded in the database with similarity edges to any known peers. In this case, similar or peer organizations are determined in real-time with the recommendation. Rather than calculate peer values for all organizations with the user's organization, it is computationally more efficient to determine a set of organizations (clients) that receive goods or services from organizations (vendors) that are relevant to the search criteria and then calculate a similarity or peer score between each selected client and the user's organization.

A similarity edge may include a value measuring the degree of similarity or relevance. Alternatively or additionally, similarity edges may be recorded as either TRUE or FALSE. The similarity edge may include a text or code indicating the nature of the similarity (e.g. “small biotech peers”, “large banks”, “subsidiaries of XYZ Corp”). The nature of the similarity may be output to a user to indicate how organizations are similar.

In preferred embodiments, similarity between two organizations is calculated using multiple algorithms, which consider different factors such as attribute data and co-occurrence in media. The scores from these algorithms are weighted and combined to reach a similarity value.

As used herein, the terms ‘similar’ and ‘peers’ are related. Organizations may be considered similar because they have many attributes in common. Peers are similar with the added provision that they are in the same or related industry/sector/specialism and/or offer related products or services. Thus two organizations that have similar attribute data for size, location, and age are considered similar but may not be considered peers if they have different organization type data such as industry or sector. Two organizations in the same industry are considered peers, and comparing attribute data, such as revenue, location, and specialism, can further refine the peer score. The skilled person will appreciate there are many known algorithms to calculate similarity metrics and/or perform peer clustering using attributes. For example, similarity metrics could be based on Jaccard similarity coefficients or cosine distance, and peers could be clustered using expectation maximization, hierarchical clustering or density-based clustering algorithms.

Alternatively or additionally, similarity can be determined by co-occurrence in journals and social media. This can be done by searching for names of two organizations or their products appearing in the same individual blog, microblog or industry journal article. Co-occurrence can also be found by noting the frequency with which people view both organizations in a session. The co-occurrence approach is inherently less quantifiable but has the advantage of crowdsourcing to determine which organizations are actually perceived as peers or similar.

### Classification

An organization may be described according to an infinite array of properties, using a huge variety of terms, many of which are synonymous. In order to group together similar companies and tabulate attribute data by attribute values it is useful to use consistent, defined terms or ranges for the attribute values. Company A may be a baker located in San Jose and have 8 employees. Company B may be a café in San Francisco and have 5 employees. Both may be classified as companies in the retail food and drink sector, located in the San Francisco Bay Area with less than ten employees. This significantly reduces later processing times because there are now a limited number of attribute values to compare.

The database preferably includes an attribute data structure having a limited number of classes and, for each class, a limited number of standard values. Example classes would be city or number of employees. Example values for these classes would be Boston/London/Madrid or 5-10/100-500, respectively. A classifier agent includes means to classify data about an organization into a plurality of classes and store them in the database. For example the classifier may be a Decision Tree, Random Decision Forests, or Naïve Bayesian Classifiers available from machine learning tools such as SciKit Learn or Weka. For each standard term there is a vocabulary of synonyms. The classifier parses through an organization's profile data or scrapes the organization's webpage or other records for phrases and terms that are likely to be descriptive of the organization. These phrases and terms are compared to the vocabularies to determine the most suitable attribute value. The attributes are stored in the database for that organization. Tools such as WordNet or algorithms based on co-occurrence statistics enable an algorithm to automate such synonym discovery to classify terms.

The system may employ a search engine, which uses the vocabulary lists to hash a user's free-text search string to the equivalent standard term for an attribute value. For example, a search for ‘a patisserie in the Bay’ would lead to ‘patisserie’ being matched to the standard term ‘baker’, whilst the term ‘Bay’ is matched to more than one location. The method would return all organizations having the attribute ‘Baker’ with locations associated with San Francisco Bay, Bay of Fundy, Bay of Biscay, etc.

Many classes and ranges may have one or more parent values or ranges, such as the NAICS system used to classify industry. For example, a winery could be classed in the Food and Beverage sector, the Beverage subsector, Alcoholic Beverages group, or the Wine Manufacturing subgroup. Moreover many companies may have attribute data in more than one class, such as the largest blue chip companies that serve many sectors, have products in different classes, and have subsidiary companies with very different employee counts. The database is preferably arranged to store sufficient attribute data to describe the organizations and the system includes software agents to classify and compare organizations across a plurality of attributes and levels.

### Recommendation Engine

A request to view data from the database may take the form of a search string or clicking on a hyperlink or filter button for an attribute or name. The request may come indirectly via a third party link or from search results. A request to view data about a particular organization may be answered by returning an organization's profile webpage. The present organization recommendation engine accepts such requests at the webserver and returns a set of matching and recommended organizations with context that is offered as relevant to the user's organization

The recommendation engine is a system including a database, processors, and software to provide a personalized recommendation of an organization for another organization. For simplicity, in the discussion hereafter, the entity for which a recommendation is sought shall be referred to as the user's organization (aka first organization), the organizations being sought shall be referred to as vendors (aka second organizations), and organizations receiving goods or services form the vendors shall be referred to as clients (aka third organizations). This supposes that a user wants to know from what vendors he should buy goods or services based on what clients use that vendor and are similar to the user. It will be appreciated that the search is not always directed at finding a vendor and that the organizations connected to a vendor are not always clients in the relationship. It will also be appreciated that the system will be used by an employee, automated search tools or a broker to search on behalf of the first organization.

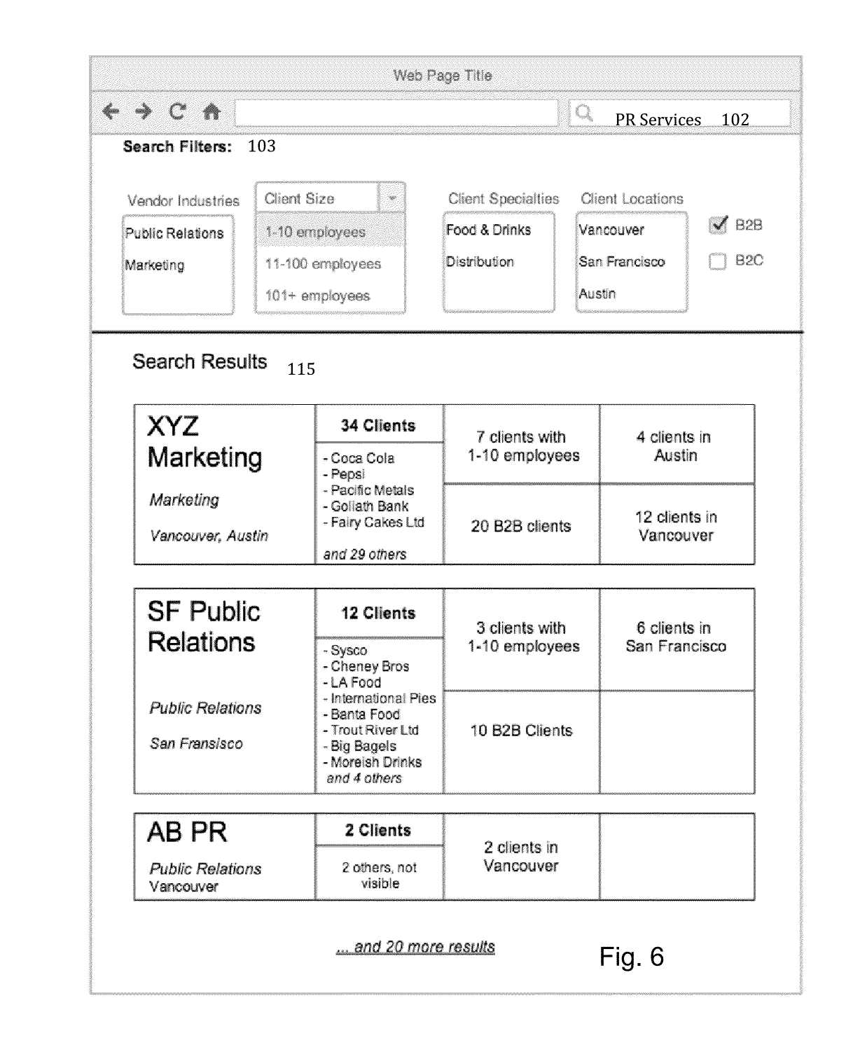

As illustrated in FIG. 6, a user interfaces with the recommendation engine and provides identification or attribute data about the searching organization, criteria about the organization being sought 102 and any filter criteria 103 that they wish the engine to consider. The output is a data set of recommendations 115, optionally including a score or ranking for each organization.

Using keywords or selecting hyperlinks, the user indicates one or more criteria for the search of second organizations. Preferably the criteria are directed to organization type data. Examples of organization type data for a law firm include: law firm; lawyers; specializing in contact negotiation; and legal services. Whereas size, revenue, and location are examples of attribute data that would not indicate the type of an organization, but they could be used as criteria to refine the search, either as an input with the organization type criteria or selected during a subsequent step. The engine retrieves a set of data collections of second organizations from the database that match the criteria.

In order to personalize the recommendation of second organizations, the engine determines or receives identification data for the first organization or at least some attribute data for the first organization. In one embodiment, the engine receives data identifying the user's organization such as name, web domain, email address, IP address, or company registration number, etc. Preferably a user logs into a web portal accessing the recommendation engine with a company name or company email address. Alternatively identification may be determined by looking up the owner of the IP address of the user. Identification data can be used to determine attributes of the first organization, either with reference to the database or by scraping data from the Internet in real-time. Attribute data is used in similarity algorithms as discussed above. The identity data, if available, is further used to calculate similarity based on co-occurrence of organization names in media.

Users who wish to remain anonymous or wish not to log in may still receive a personalized recommendation by describing their organization. The description preferably includes attribute data, preferably organization type data, which could be entered as text or through menus on the interface. Example descriptions include: small business, London, $40 m revenue, hotel management, conference services.

The recommendation engine retrieves a set of data collections of third organizations from the database that are similar to the user's organization or have a relevant relationship with one of the second organizations that is relevant to the criteria.

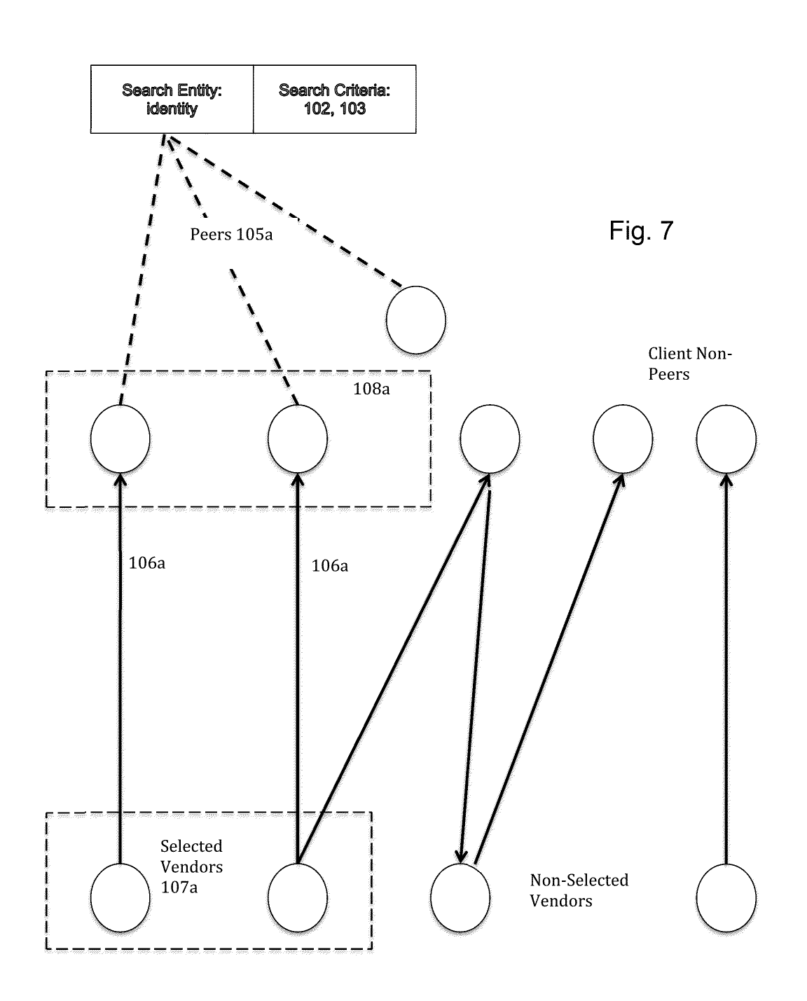

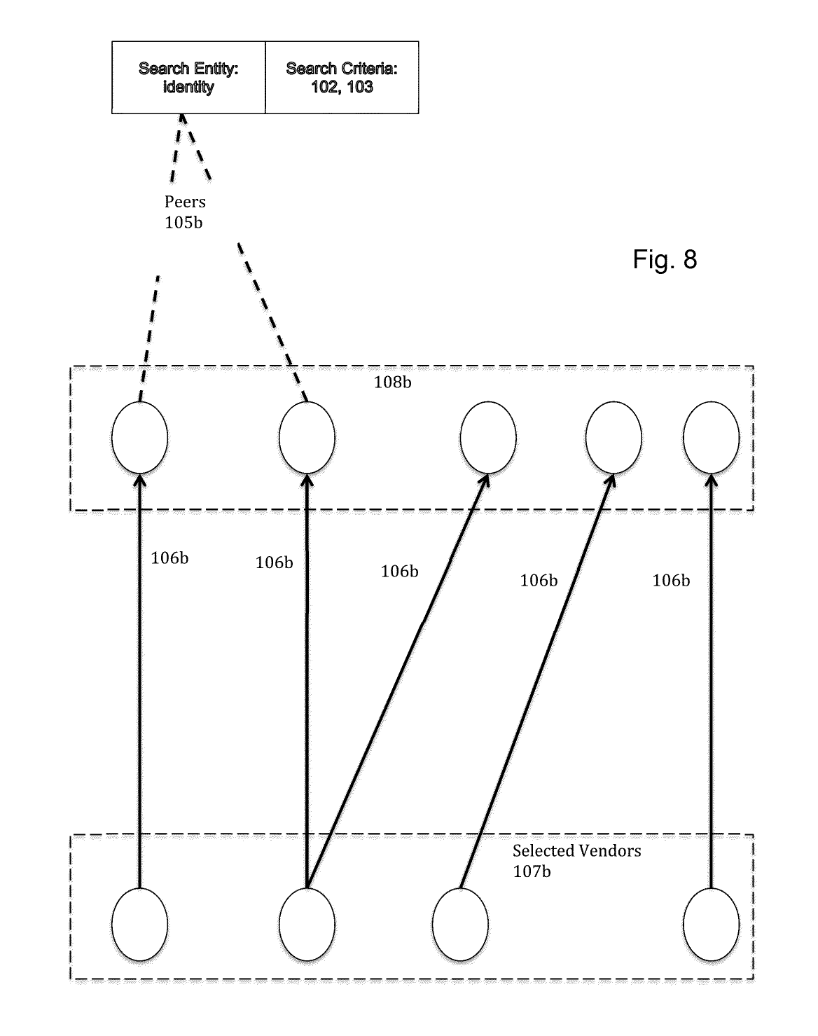

For the purpose of the recommendation, the database can now be seen as reduced to comprising a set of data collections of second organizations, a set data collections of third organizations, and relationship data between second and third organizations. The engine may create the recommendations from the sets in at least two ways, as illustrated by FIGS. 7 and 8, or using combinations thereof.

In a first embodiment illustrated by the flow diagram of FIG. 7, the engine determines all the organizations 105a in the database that are peers of or similar to the user's entity. The engine then finds relationships (106a) in the database for each organization 105a and creates a set of potential vendor organizations. The engine determines whether each of these organizations matches the organization type being sought to create a set of second organizations 107a.

In another embodiment illustrated by the flow diagram of FIG. 8, the engine determines which organizations in the database match the organization type being sought to create set 107b of vendors (second organizations). The engine then finds all relationships 106b in the database for each vendor to create set 108b of clients (third organizations). The engine may use the relationship direction attribute stored in the database to ignore connected organizations that are not actually clients to each vendor or use this knowledge to weight their relevance. Thus for recommending a vendor, the suppliers to that vendor are ignored or lowly weighted compared to clients of that vendor.

The engine then determines which clients 108b are peers 105b of or similar to the user to create a set of third organizations.

The engine thus creates vendor set 107a or 107b, which may well be different and creates client/Peer set 108a or 108b, which may well be different. In general sets generated by the route of FIG. 7 will be smaller than those generated by the route of FIG. 8. For example 108a will contain clients that are also peers, whilst 108b will contain all clients, some of which will not be peers. In a mixed embodiment, the engine may start with one route to create sets and then iterate to amend the sets using the other route. For example the Engine may create a set of peers, determine relevant vendors connected to peers, then create a set of all clients of those vendors. Some of the clients will be the original peers and very relevant to the user's organization whilst others will now be non-peers but may still included in calculating a recommendation metric.

Potentially the sets may be very large for crowded industries with many recorded connections. Through a web interface, the user may be offered a selection of filter criteria for each set (clients and vendors) to exclude or limit the set of output vendors. For example the engine may exclude certain clients under a certain size or limit the output to vendors at certain locations. The user may also be able to filter on the names of vendors or client. Thus the Engine provides means of filtering the output vendor set based on attribute data and identity data of clients and/or vendors. Filtering may be performed at any stage. For example, having received 500 vendors, each with 100 clients, a user may choose to limit the displayed data to vendors with more than a threshold revenue amount, located in New York, and whose role in the relationships is as supplier of cosmetics.

The set of vendors may be output as an unordered set of all vendors suited for the user. To provide a more personalized view to the user, the engine preferable processes the vendor set according to a metric, such that a subset of vendors is output corresponding to the most relevant or highest scoring vendors.

In one embodiment, the engine uses the metric to determine whether each vendor is more or less suitable than another to output an ordered set of vendors.

In another embodiment, the engine computes the metric as a score for each vendor and outputs the vendors according to the scoring and optionally outputs the score itself.

It is also possible to combine the above methods. For example the engine may calculate a rough score to order the vendors, then perform direct comparisons between close scoring vendors, and then limit the output to only the top ten vendors.

The personalized recommendation metric may be calculated as a vector distance using attributes of first, second and third organizations to determine the second parties closest to the first party. The metric may also be calculated as a sum of weighted relationships or similarities to determine the highest score for each second organization.

The engine may calculate the recommendation metric for each vendor based on the sum of similarity values between the user and each client of that vendor. The engine may compare attribute data of these organizations as discusses elsewhere. The recommendation metric may be amended by multiplying each similarity value by a relationship value, which indicates the strength of the relationship between second and third organizations. The similarity and relationships values are preferably stored as attributes of the respective edges in the database. These values may be TRUE/FALSE but preferably are weighted to indicate more or less similarity or relationship strength.

The engine may amend the recommendation metric by calculating a relevancy metric based on the relevance of attributes of second organizations to the criteria for the recommendation. Preferably this calculates the relevance metric based on the organization type of the vendor and the type of organization sought. For example a shipping company is considered more relevant to the criteria of “shipping services” than a law firm that provides legal service to the shipping industry. The reverse recommendation would be made if the criteria were, “services to the shipping industry”. Therefore a search term may be contextualized and hashed to an appropriate organization descriptor, which is then compared to the appropriate attribute data stored with the vendor or relationship.

Returning to FIG. 9, a search for legal services (matched by nodes D, E, F) yields the reduced graph representation of FIG. 9B. This shows the core recommendation data needed to provide a personalized recommendation to organization A, where only peer edges from A to peers (B, C) and relationship edges from matching vendors (D, E) to client nodes (B, C) are considered. The weights of the edges are shown here for calculations below.

The result in FIG. 9B may be derived by starting from all matching vendor nodes (D, E, F), following all outward relationship edges to determine their client nodes (G, B, C), and then following all inbound peer edges from those client nodes to determine the peers (B, C) of A, for whom the recommendation is intended. Alternatively or additionally the same result may be derived by starting from A and following all outbound peer edges to find peer nodes (B, C) and then follow all inbound relationship edges from peers to find matching vendor nodes (D, E).

A personalized recommendation for organization A is made by calculating a metric for each vendor as the sum of the weighted paths from A to D and E, whereby: Score D=0.3×0.8+0.7×0.4=0.52 and Score E=0.6×0.8=0.48

The skilled person will appreciate that alternative algorithms and weightings may be used to calculate a metric for each vendor within the spirit of the invention and the invention is not intended to be limited to any particular algorithm.

Optionally the recommendation engine may supplement the personalized recommendation by including vendor nodes that do not have paths to peers of the user's organization. In FIG. 9, vendor F is does not supply services to a peer of A, notwithstanding that it receives services from a peer of A, and so does not score on the personalized system. However, it could nonetheless be output to the user as a vendor matching the search criteria, but with a lower rank than vendors D and E.

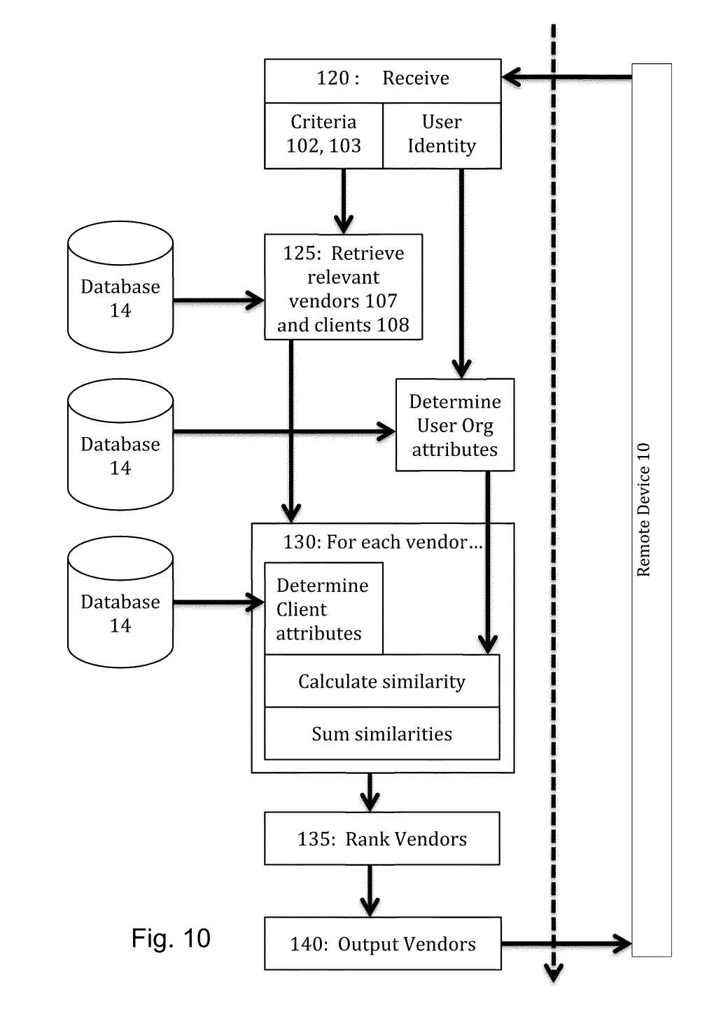

FIG. 10 is a flow diagram showing the flow of data and connections between software agents according to one embodiment. It is related to the process shown in FIG. 8 but the skilled person will appreciate that the agents may be re-ordered to determine peers of the user's organization before vendors, as illustrated in FIG. 7.

In FIG. 10, a remote device 10 makes a query based on criteria 102, 103 on behalf of an organization (shown as the user's org here). The criteria data is sent to a receiving agent 120 to find vendors from the database 14 that match the criteria. The database returns data about matching vendors 107, their clients 108 and the relationships between them. The identification data is sent to an attribute agent to find the attributes of the user's organization from the database.

For each vendor, the recommendation metric agent 130 calculates the sum of similarities between attributes of clients and the user's organization. A ranking agent 135 then compares the metrics for each vendor to determine an order to the vendors for the purpose of this user's organization. The output agent 140 determines how many of the vendors to output and what data, such as aggregated client attribute data and vendor attribute data, should accompany each vendor. The output data is sent to the device requesting the recommendation.

### Displaying Data

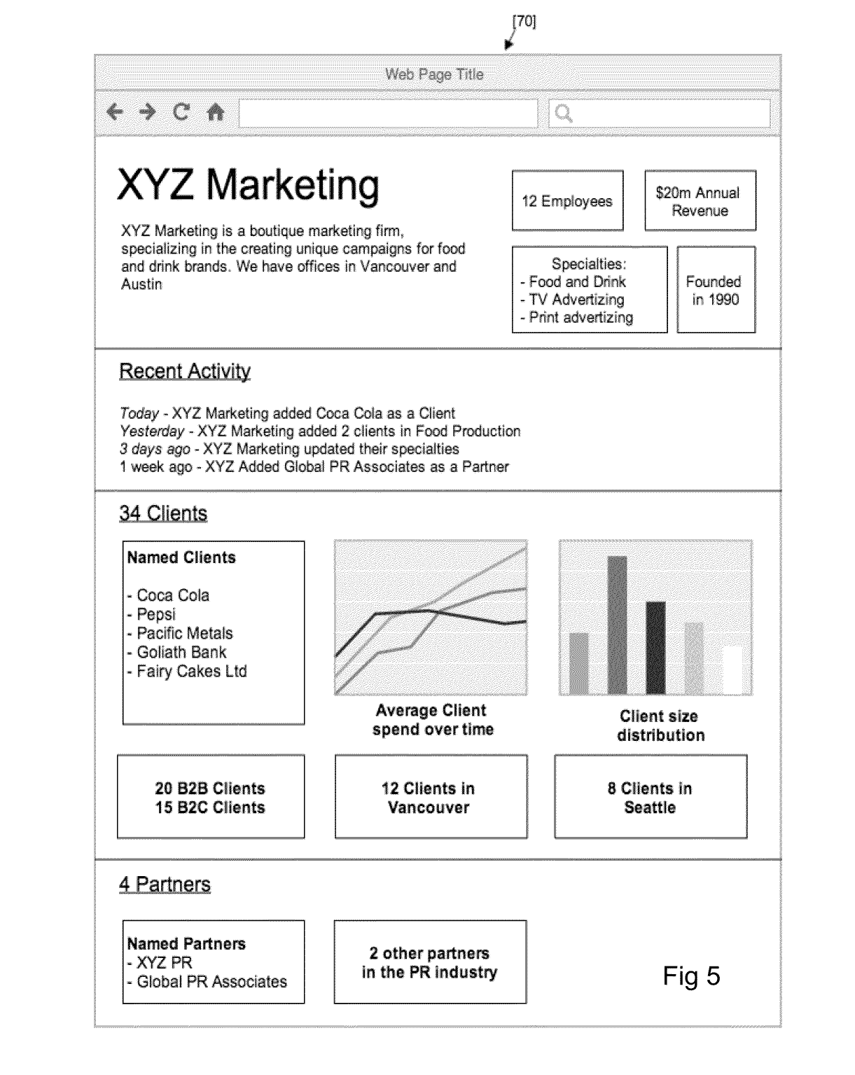

In an example illustrated in FIG. 5, a webpage 70 is displayed in response to a request to see information related to company ‘XYZ Marketing’. The webpage displays the company's profile in free text, graphics and the aggregated attribute values of its clients. The webpage displays that ‘XYZ’ supplies 34 clients, wherein twelve are located in Vancouver and eight are located in Seattle (and therefore some locations are undisclosed). Certain named clients are identified.

Certain quantifiable attribute data may be aggregated and displayed as graphs and charts. For example, for each second organization the total number of connected third organizations in each sector or location could be tallied and displayed. This allows a viewer to make a meaningful interpretation of the huge number of relationships, even when some of the organizations are hidden. Whilst the name of a connected organization may provide a specific example, in many cases it is sufficient to understand an organization's business by evaluating how many connected organizations are in a certain industry or location, or have a certain revenue or size. The aggregation agent determines the count of third parties with attributes matching each attribute value.

Different attribute values may be selected depending on which attribute values have the highest aggregated count for each second organization or depending on the attribute value's relevance to the user's organization. For example, a vendor may have ten clients with the industry value ‘bank’, five clients with the value ‘baker’, twenty clients with the location value ‘Boston’ and two clients with the value ‘London’. If the location attribute class is less important to the user, it may be ignored or only the location value with the highest count (Boston) may be output. If the industry attribute class is very important, then the industry value that is most similar to the first organization is selected and output. Thus for each vendor (second organization), one or more attribute values are selected based on the relevance of the attribute class and attribute value to the user's organization, and their aggregated count is displayed.

The aggregation agent may also aggregate the relationship attributes data for each vendor. The output agent can select the highest count or most relevant relationship attribute value to display. For example, the system can display which firm has the most clients receiving particularly relevant service type.

FIG. 6 is an example webpage displaying results from a search for public relations firms. The user interface may enable the user to search by keywords and attribute filters to identify the most relevant criteria. Preferably the filters relate to divisions within each attribute to simplify and group the options for searching. As shown, the user can filter on specialty, location, industry and size. Alternatively or additionally, for each second organization, the aggregated attribute data is displayed as a natural language statement about the third organizations to provide a user-friendly output.

In this example, three companies are highlighted with details. A summarized profile of each organization is provided with hyperlinks to each organization's main profile page.

In some cases not all of the matching records will be selected. For example, the program may select the first 50 relationship records for a particular organization or select only those relationships for a searched organization which are deemed significant, in terms of value or quantity or appear more relevant to the user's organization.

The method may not output all data for all second organizations of all relationships selected. The method may limit the output to a predetermined number of identified organizations and/or attribute values or choose which organizations or attribute values to output. This is useful in reducing the data stream to be transmitted or displayed on a screen to a manageable amount. For example, the connections for a large company may involve thousands of relationships and organizations so the program may choose to output only certain connected organizations and certain attributes values that are most numerous or deemed most relevant. FIG. 8 illustrates that in addition to the three displayed companies, 20 more results exist (that are not displayed).

The method may be used to output data to create a profile page for a particular organization or attribute and these pages are stored for subsequent retrieval by a user. In this case, the method can be performed offline and retrieved when a particular profile is requested.

To preserve the visibility wishes of the user inputting their connection, the output agent does not output identification data of organizations marked as hidden in a particular relationship. The data retrieval agent and recommendation engine may still access attribute data, use it to compute metrics, and display the attributes or metrics using the hidden organizations but will not display their identification data.

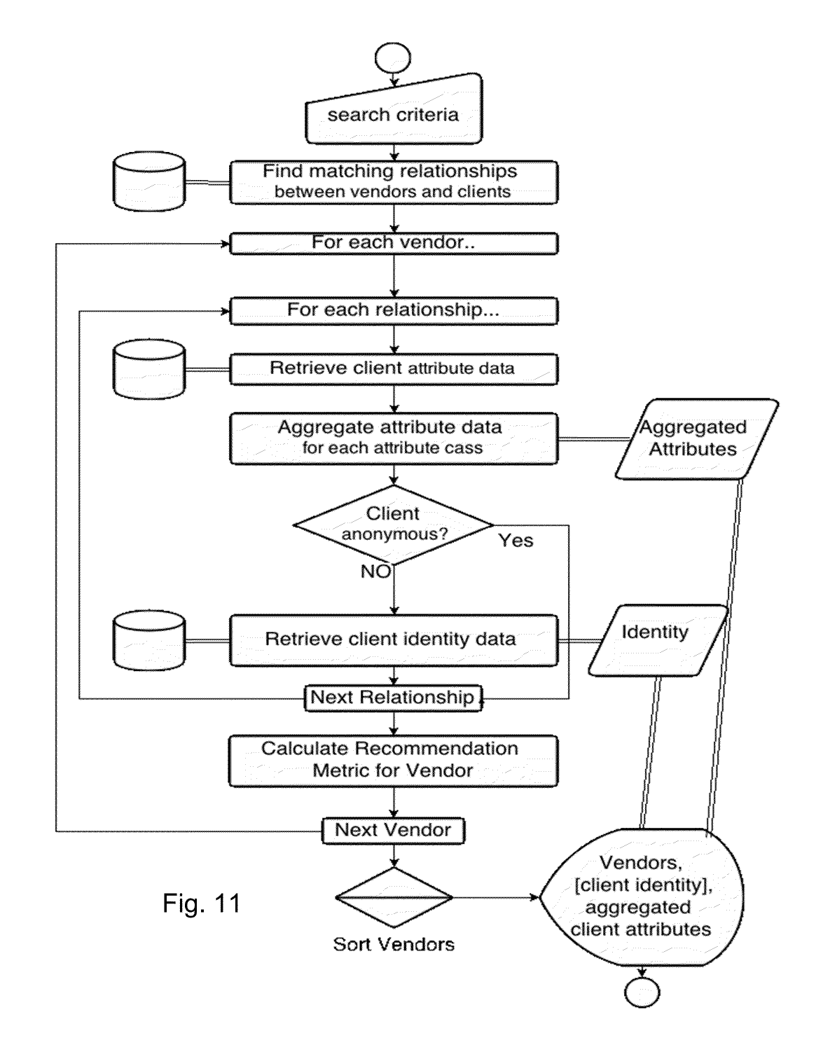

FIG. 11 is an example workflow for retrieving and outputting data from the database. For simplicity, the example flow depicts a search for vendors, some of which have listed some of their clients as hidden, but analogous workflows could be used for other relationship types. As disclosed above, search criteria is received by the webserver and matching relationships and organizations are identified in the database. The system iterates through the vendors and relationships in order to compute a recommendation for each vendor and a set of vendors is output to the user's web browser.

At some point in the workflow, the system determines, for each relationship, whether one of the organizations is marked as hidden or visible in that relationship. This status determines what the system will do with their identification data. The system may retrieve data for each organization and then display identification data only for visible organizations. In either case, the attribute data may be retrieved for hidden and visible organizations. The similarity scores of the user's organization to both hidden and visible organizations may be used to calculate a recommendation metric for vendors.

The system prepares web content using identity data and attribute data of organizations marked as visible, and attribute data but not identification data for organizations marked as hidden. Attributes of both hidden and visible organizations may be aggregated and output. The system may select identification data of one or more visible organizations for output.

A serialization agent serializes the web content in a format readable by the user's web browser and communicates said web content, over a network, to the client-computing device making the initial request.

### Verification

Typically, social networks require both parties in a proposed relationship to confirm the relationship and until such time, certain actions or views are inaccessible. The present inventors have appreciated that in a business context, an organization may have less reason to confirm relationships, even if a user can be found that is appropriately authorized to act on behalf of an organization. Therefore the system is arranged to allow some relationship data to be input by a user that may not be confirmed by the connecting organization and yet still allow access to functions and views of the relationship. In order to prevent fraudulent gaming of the present social network by a company that claims to be connected to many other companies, the system includes means, preferably a plurality of means, to verify at least some of the asserted relationships.

Preferably there is a verification agent that determines whether a relationship needs to be verified at all, and if so selects one or more verification schemes to verify an asserted relationship. In order to balance the desire to ensure honest use of the system, user trust in the truth of the database and desire to lessen the burden for inputting relationships, the verification agent preferably uses a sampling algorithm to determine whether an unverified relationship record will be tested. In one embodiment the sampling algorithm generates a random number and compares this to a threshold, preferably wherein the threshold depends on the desired proportion of relationships to test. The threshold may be further customized for an organization depending on its trust score or percent of current relationships that have been verified. For example, in a system implementing a target of 40% verification (Target) and for a company already achieving 55% verified (Current), the verification agent will generate a random number 0.32 (Random) and elect verification according to either exemplary equation below.

i. Verify if Random<2*Target−Current (i) or

ii. Verify if Random<Target̂2/Current (ii)

In this numerical example the new relationship would be tested if using equation (i) but not (ii). It is clear that equivalent algorithms may be implemented wherein steps of selecting and implementing a verification scheme are contingent upon the relationship being selected according to a sampling algorithm.

The selection of schemes depends on some measure of trust in the user or organization asserting the relationship data. Thus for organizations having a high trust score in the database, the verification agent may select a less rigorous verification scheme or not require verification for at least some relationships. Alternatively or additionally, the selection depends on success of verification schemes previously selected for the asserting organization. Thus if a particular organization's inputted relationships were successfully verified by crawling web content from a particular industry journal, then the verification agent will initially select the web crawling scheme to verify the next relationship. Each relationship object includes data about the source of the verification, if any were successful.

In the case of a user entering relationship data, the verification means may include a field on a user-interface entry form, which field requests supporting details such as a contact name, phone number or email address for an organization not entering the relationship entry (the unverified organization). The verification agent may check a database to find contact details for an organization or check that any provided contact details are correct. Alternatively the user may input a URL for a webpage where support for the relationship can be found. The verification agent may perform an independent search to determine if the claimed relationship is true.

In one verification method, the verification agent communicates with a person associated with the unverified organization. This URL may be sent by electronic communications means (e.g. email, SMS, instant messenger) to a domain or email owned by the unverified party. The communication may be a unique URL, which enables a user to indicate whether their organization confirms, rejects, or wants to edit the details of the relationship. The agent determines whether the person following the URL came from an authorized email domain or IP address of the second organization. Following the URL may itself may indicate the response or may lead to a website where a choice is made. The website may provide a user with an option to log in using an account verified as associated with the unverified organization or with a LinkedIn account, in which case the verification agent checks whether the user works for the unverified organization, preferably having a job title indicative of someone able to act on behalf of the unverified organization. The agent provides the verifying user with an interface to review the relationship data and suggest additions or changes regarding their own organization or the nature of the relationship, including period of the relationship, star-rating, monetary value, or the type of services/goods provided.

In another verification method, the verification agent retrieves a webpage address or electronic document that is input by the user. For example the support may come from a news article, Tweet, press release, contract, invoice, or document submitted to a government body. The agent scrapes the webpage or document, using natural language processing, to determine whether there is support for the relationship as claimed. The scraper can search the metadata in the document markup language for both organization's names, links to their home pages, or to logos which are then cross-reference to a library. The agent scrapes the text for the names of the organizations and words or phrases indicative of a business connection such as “A begins a joint venture with B” and “X supplies legal services to Y.” The business connection words or phrases may be stored as a glossary.

In another verification method, any or all of the steps of entering new relationships, confirming them and maintaining them may be performed by coupling the present system with Customer Relationship Management (CRM) software, such as Salesforce Inc.™ For example a CRM account could be coupled to an account of the present business social network, whereby API calls can synchronize business relationships between accounts. The user may install an add-on to the CRM software which provides the server 10 with permissions to view relationship data. Server 10 may call the CRM's API to perform batch updates or the CRM may call server 10 API for real-time update. This provides some level of confidence in the relationship, with the further benefit of enabling changes to the relationship, including termination, to be updated quickly and seamlessly. The skilled person will appreciate that software other than CRM may be coupled and that such software and the present social network may be part of the same overall system.

In yet another verification method, the verification agent performs an independent search of websites, social media, or third-party databases to corroborate the relationship. Such webpages may include the news and investment webpages of the organizations involved, articles in online industry journals, conference publications, and organization profile pages. Social media sources may include LinkedIn, Facebook, and Twitter, where users may post text on an organization's account that supports the claimed relationship. For example, an employee of XYZ Corp could Tweet about a new marketing relationship and contemporaneously enter it on the presently disclosed system. Similar to the case of a user-directed website above, the web crawler preferably detects the co-occurrence of both parties in a single web content, more preferably connected by words that indicate a relationship exists. Third-party database sources include SEC filings, Court records, NIH grants, share dealings, patent offices, investments records, and customs filings. Provided these databases are authenticated as unbiased, the verification agent can scrape these for corroborating data true through their digital portals. The verification agent may maintain a list of authenticated websites including news about each industry and verify claimed relationships there. Vice versa, the agent may build such a list from the websites referenced by confirmed relationships. The verification agent may determine the industry of each organization in the relationship, select one or more news websites relevant to those industries and electronically search for the co-occurrence of each organization, as discussed above.

The above verification methods and equivalent variations thereof may be combined in parallel or in sequence to derive a confidence score. The user may select a scheme or the agent may select the scheme according to trust scores and internal rules. These schemes are expected to be run external to the user's experience and may take days to confirm. Confirmation or partial confirmation increases the confidence score by an amount dependent on the verification scheme used. In some cases, the results will be inconclusive, in which case the relationship may retain its initial confidence score. The verification agent may select another scheme if the confidence score is below a threshold.

The verification agent may also estimate the confidence score using trust in an organization as a proxy. For example, the confidence may be set to the trust score or trust ratio (see below) of the organization that input the relationship.

As a numerical example, an employee of a large vendor inputs a marketing relationship with a small client. A relationship edge is created with an initial confidence score of 0.3 (out of 1.0) to reflect the vendor's high trustworthiness and small advantage gained for adding a small client. The value is high enough that the relationship counts towards an aggregated count of small clients served by the vendor. The employee enters the email address of her contact at the client. The verification agent sends an email to that address. No response is received after a week and the confidence score remains below the threshold of 0.6 for displaying a relationship, so the employee directs the agent to the vendor's website where the client is mentioned. An ambiguous mention is detected by text scraping, so the agent only increases the confidence to 0.4 and so the agent performs an independent search of a marketing journal website. Dominant use of both organization names is detected in a single article, so the confidence score is increased to 0.7. The client's name now appears to viewers on the vendor's profile page. Eventually the client confirms the relationship and the confidence score is increased to 1.0.

The agent may also determine a confidence score using heuristics, game theory, and behavioral modeling to determine, for example, the likelihood that the relationship is possible, whether a user is abusing the system, whether there was an error, or whether the relationship is different to the organization's normal specialism. For example the agent could automatically reject a relationship (on at least three grounds) in which “an oil company has provided legal advice to Greenpeace since 1963”.

The verification agent may maintain a model of ‘normal’ relationships. The model may use Big Data to determine patterns of clients—vendors relationship. Attributes of the vendors and clients can be used to determined patterns or classes. This model may also be performed for a particular vendor to determine patterns of its clients. The model may be use supervised machine learning techniques on verified relationships. For example, the model may determine that vendors providing certain services tend to have clients of a certain size and industry.

The model is then applied to individual unverified relationships to detect outliers—departures from the modeled norm. The model may calculate a probability of a given relationship being true. Certain models may perform clustering of relationships/clients using relationship/client attributes and calculate the probability from the inverse of distance of an unverified client. The probability may be used to calculate a relationship's confidence score. The probability may be compared to a threshold to set the verification status to TRUE or FALSE.

The result of the verification process is an update of a confidence score of the relationship record. A new unverified relationship may be initialized with a zero (Boolean FALSE) or minimal confidence score. If the verification agent confirms the relationship, it sets the confidence score to one/TRUE/maximum. The skilled person will appreciate that these numerical scores are arbitrary and other ranges or interpretations of scores may be used without departing from the concept of confidence about a relationship record. For example, a non-confidence score may be implemented instead to record the extent that the relationship is not verified.

The verification agent may further include heuristic and/or correction algorithms to determine whether the confidence score is fair. For example the agent may include a plurality of checks that the confidence score has not been fraudulently elevated by relationship confirmations from dummy organizations or untrustworthy websites. The agent may adjust the confidence score using these heuristic and/or correction algorithms after or as part of the verification and scoring algorithm.

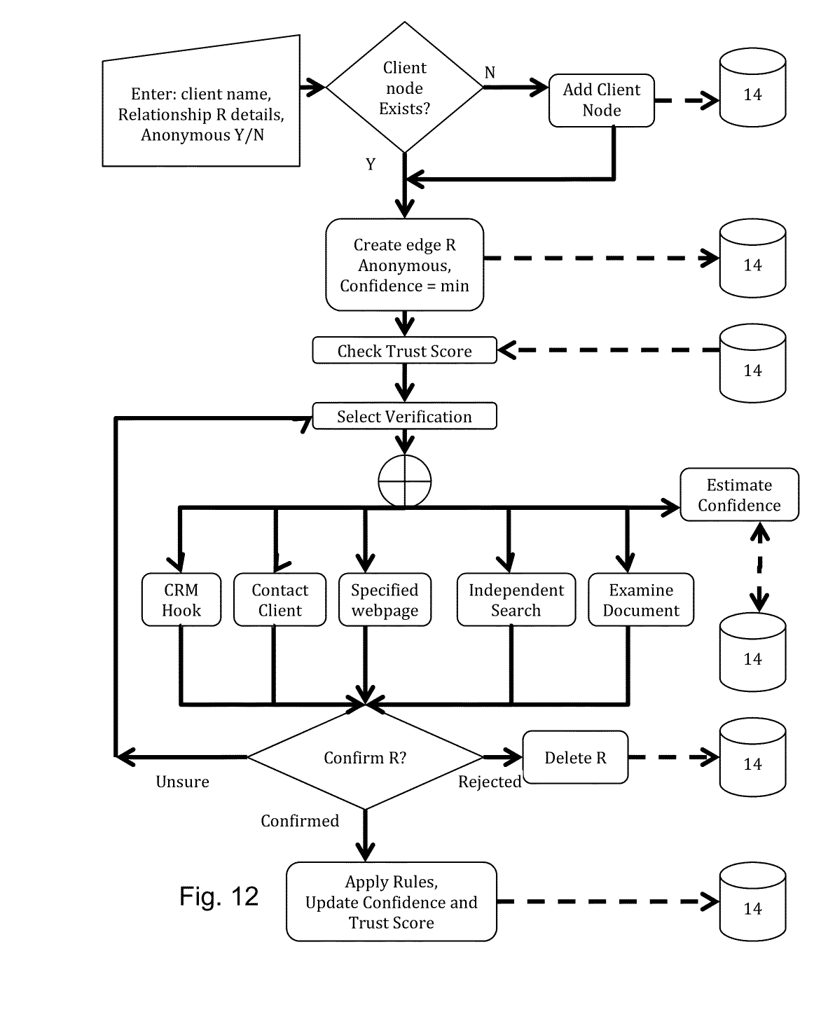

FIG. 12 is an example flowchart for a process of verifying a relationship record. The flowchart is displayed for a user working for a vendor entering details about a relationship R with a client but in principle the process would be similar for a relationship between any two organizations that was input by a search bot or human user.

The user logs onto the vendor account and request to enter a new relationship. They enter the client's name, relationship details, and optionally select to make the relationship hidden (not visible to other users). If the client does not exist in the database then a new client node is created and a web crawler determines attribute data of the client. A relationship is created in the database, in this case as an edge, having two statuses, visibility and confidence. The visibility status is set to the choice selected by the user and the confidence score is set to a default, typically low, value. As an alternative, the system's rules may default the confidence to a high value, such that relationships are effectively deemed to be true unless proven otherwise.

The results of the selected verification scheme are used to determine whether the relationship is deemed confirmed, rejected, or non-confirmed/unsure. The first two possibilities are derived from a deliberate action by the confirming client or from definitive support found in a webpage. A lack of a response or inconclusive support may be used to select another verification scheme or prompt the vendor for more proof. For a rejection, the relationship record is deleted from the database. For a confirmation, the verification agent considers whether any rules or multipliers are warranted to reduce the confidence score to less than the maximum or to not apply the Boolean, TRUE.

In one embodiment, a recommendation metric for an organization partly depends on the strength of the relationship between organizations and the relationship confidence score. For example, a relationship metric could be calculated as the strength multiplied by the confidence, such that high-value, unverified relationships may still count towards a recommendation metric but will be underweighted until they are verified.

In another embodiment the confidence score is used when performing calculations or displaying relationships. The system may be implemented to output data from both verified and unverified relationships but mark them as such. For example a symbol could be placed next to organizations that have not been confirmed as clients of a particular vendor. Alternatively the system may be implemented to calculate metrics, aggregate attributes, and output data only from those relationships where the confidence score is beyond a threshold value.

### Event Driven Verification

According to an exemplary embodiment for verification, the verification agent verifies unverified relationships by including aspects of the relationship in communications between the vendor and a buyer.

In addition to searching for and receiving recommendations of vendors using the present engine, the user may communicate with one or more vendors. The communication takes the form of electronic communication methods well known within computing science, such as email, messaging within the present system or messaging using a third party system. Examples of social network systems include, Messages in Facebook™, InMail in LinkedIn™, or Direct Messages in Twitter™, which require that both parties are members. Users signed in to the present system give the system rights to their account on the third party platform for communicating using the third party's messaging tool.

The context of the communication may be an introduction, explaining a project of the buyer, a set of questions or a more formal request for information or proposal. The communication need not be initiated by the buyer, for example the vendor may be informed that they have been shortlisted by a buyer and thus initiate contact.

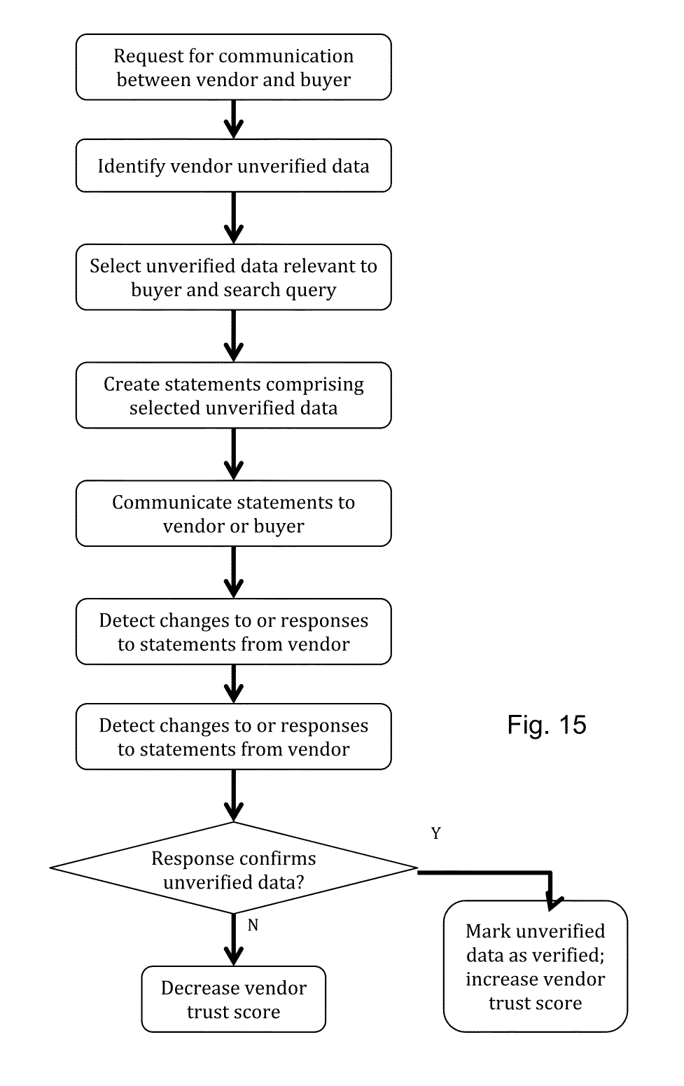

FIG. 15 illustrates an example workflow. During at least one of the communications, for example the first communication from the buyer to a given vendor, the verification agent identifies unverified data associated with the vendor The agent selects one or more of the unverified relationships/clients/attributes that are most relevant to the buyer. The agent formats text statements or questions including the selected unverified data. The text about the unverified relationship/client may take many forms designed to solicit a response from the vendor.

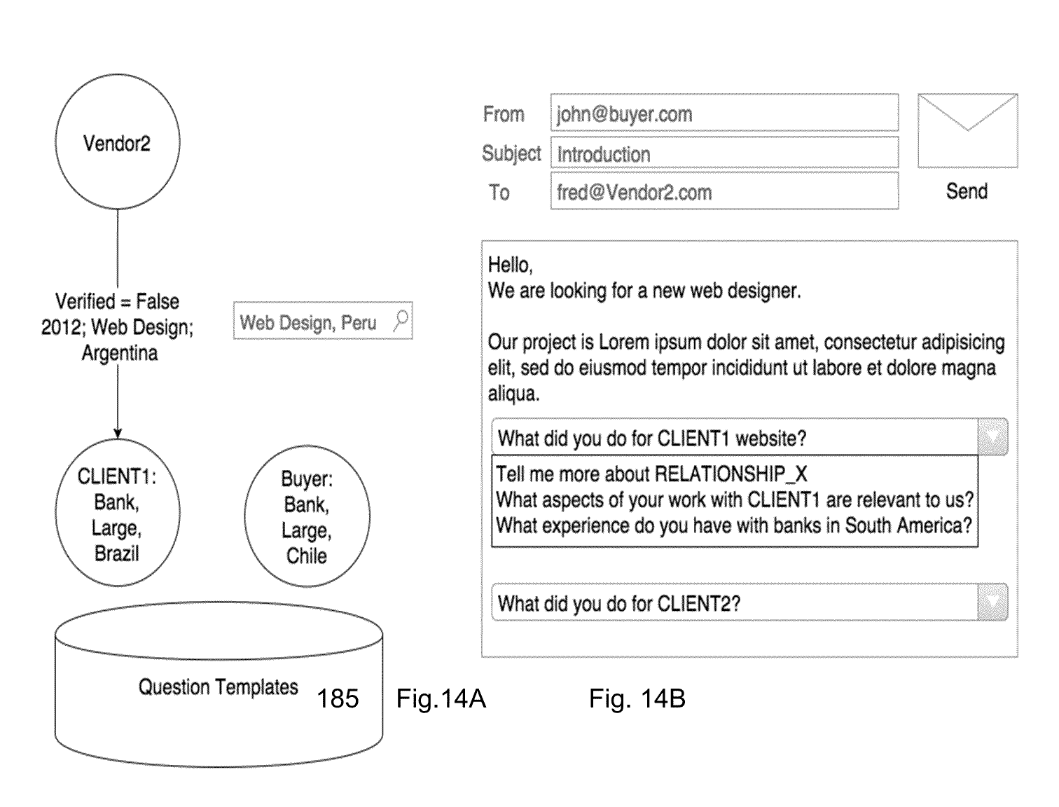

The unverified data may be a data object or attribute thereof. Examples data to verify include: a relationship data object linked to a client, a service provided, case studies, vendor attributes, and client attributes. The source of the unverified data may be a vendor-user or websites/databases accessed by the present system where the quality of computer interpretation is dubious. For example, in FIG. 14A the entire relationship may be a lie or linked to the wrong client; there might be no real company called Client1; or the attributes of those objects might be wrong.

In certain embodiments, the proposed text is displayed to the user to be accepted/rejected/amended before sending with the user's own text in the communication. In other embodiments, the text is appended to the user's own text.

In one embodiment, the relevance is calculated from similarity of the buyer's organization to the unverified client and/or b) similarity of the service described in the unverified relationship to the service requested by the buyer-user. This may be a weighted combination of attribute/service similarities. The N-most relevant unverified data that are greater than a threshold relevance are selected, where N is predefined by the administrator, preferably in relation to the number of statements that can reasonably be displayed on the client-computing device.

FIG. 14A illustrates a portion of a database comprising unverified data objects and FIG. 14B is a user-interface for selecting and communicating certain unverified data. In this example, the data objects indicate that Vendor2 has an unverified relationship with Client1, the relationship and client each having attributes. Dozens of other vendors and relationships exist but are not shown here. A buyer, having certain attributes, inputs a search query for a service and location in order to select vendors. The verification agent selects the shown relationship as satisfying the query and Client1 as similar to the buyer, based on the attributes. The names and attributes are combined with template questions from question database 185 or used in a Natural Language Generation model to create a set of statements.

In FIG. 14B the set of statements are auto-suggested using drop-down menus for inclusion in the body of the message, along with text written by the user. The user selects the relationships of most interest and the form of most interest.

In certain embodiments, the verification agent may suggest that the vendor-user prepare communication with regards to certain unverified relationships, as a proactive step rather than in response to a question from the buyer. As above, the verification agent identifies unverified relationship and selects those most relevant to the buyer. In a communication to the buyer, the agent may suggest that the vendor-user discuss details of the selected unverified relationship or the agent may append data or statements about the selected unverified relationships to the vendor's communication.

The verification agent monitors any communication from the vendor to the buyer for details about the unverified relationships/clients so as to update the verification status, confirmation score or vendor trust score based on said details. The agent may use machine learning and natural language processing to identify sentiment, attribute data, sample work, depth of details or a simple confirmation/rejection of the unverified data. Using rules and algorithms determined by the administrator of the present system, the vendor's communication can be used to add to or confirm attributes of data objects, verify the relationship or modify confirmation/trust scores.

Depending on the rules implemented, absence of a vendor response to a statement/question sent about an unverified relationship may result in reducing the confirmation score, deleting the claimed relationship data object or no conclusion being drawn about the veracity. Similarly the agent may detect whether the vendor-user rejects suggestions for discussing unverified relationship, diminishes their portrayal of the relationship, or the communicated description of the relationship differs greatly from the data stored in the database. The agent then updates the verification status or score as appropriate.

One example rule implemented by the agent, would be to reduce the confirmation score or vendor trust score where the vendor's text is less specific or different from the data in the database, and increase the confirmation score or vendor trust score where the vendor's text is more specific or agrees with the data in the database. Thus the vendor may receive an auto-generated statement, “Give us examples of your experience in the banking industry in Argentina,” and respond “we have lots of experience in finance. We also have clients in South America. We do not have any in Argentina.” The verification agent would detect words that are dates, places, services, industries, for example by searching for the response words in vocabularies for the attributes sought. This would detect “finance,” “South America” and “Argentina.” Further processing using semantic relatedness and classification hierarchies would detect that “finance” was related to “banking” but less specific. Sentiment analysis would detect that “Argentina” was used in a negative context, arguably rejecting the attribute being tested.

Conversely a response “We designed a website promoting credit cards for a bank in Argentina in March 2012 . . . ” would be similarly analyzed to conclude that the statement corroborates and is more specific than the unverified attributes. The confirmation score is thus increased for this response.

Thus rather than verifying every relationship or randomly testing relationships having no effect in a vendor recommendation, the system can limit verification events to vendors that are actively being considered by active buyers.

### Trust

The concept of trust can be implemented by calculating a trust score for each organization. For efficiency, the trust score is calculated offline and stored in the database but the trust score could be calculated on demand. Preferably, a new organization is given an initial trust score, which increases for certain behaviours and feedback, and decreases for others. The starting score may depend on the organizations size, reputation or history. Over time the trust score for a first organization increases as second organizations confirm or input relationships involving the first organization. Conversely, the rejection of a relationship will lower the trust score. The trust score may also increase with the length of time an organization has had an account with the system. Preferably the system includes trust-scoring agents that initialize, calculate and update the trust scores using a weighted summation of positive and negative results. Various algorithms will occur to the skilled person to calculate such a trust score concept.

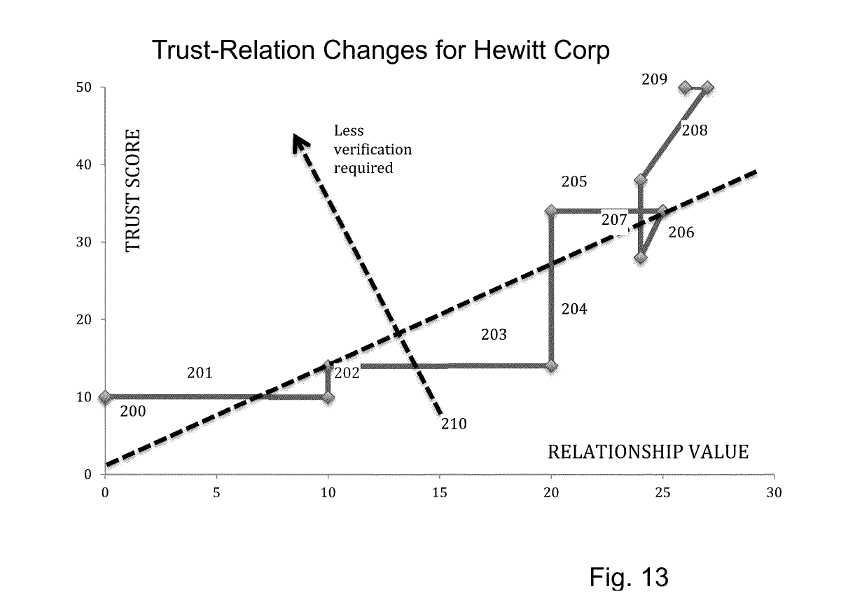

The trust scores are used by the system to enable certain functions, in particular, the inputting or displaying of relationships. As the number of relationships and/or value of relationships added to the database increases so does the trust score requirement. A trust score to relationship value ratio below a threshold will require that a positive action occur on behalf of the organization before new relationships are added or made visible to users. The system may trigger verification means to check new or existing relationships such that any positive action will increase the trust score for that organization. The threshold can be a simple ratio of trust score divided by relationship value. Alternatively the system implements a linear or non-linear dynamic threshold between trust and relationship. In FIG. 13 the threshold is illustrated by the dashed line, conceptually categorizing the state above the line as requiring less verification The threshold values is somewhat arbitrary but is chosen to implement a system policy that is fair to the value of claimed relationships and expected verification rate. The threshold could be replaced by a gradient (dashed arrow 210 in FIG. 13) or lines defining multiple zones of system behavior. In any case, the system is arranged such that organizations with lower trust to relationship ratios have more stringent verification, may need to provide more details, or are weighted less in recommendations.

The relationship value may simply be the number of relationships involving an organization or it may be a sum of relationships weighted by their value, measured by monetary value, number of employees engaged, relative amount the client spends on a vendor compared to other vendors, etc. Other measures and algorithms will occur to the skilled person to capture the concept that some relationships are larger than others and should contribute greater amounts to a recommendation.

FIG. 13 illustrates an example chart of trust score vs. relationships with a dashed threshold line for the organization, “Hewitt Corp”, over the course of the following numbered actions. The threshold ratio, confirmation and rejection multipliers are set in this example such that an organization needs about two thirds of their relationships to be confirmed. Otherwise, verification requirements become stricter. In this example, the initial trust score enables the organization to enter about seven unverified relationships before verification becomes strict.

200 An initial trust score of ten is given.

201 Hewitt adds ten low-value client relationships, which increase the relationship value by ten.

202 Two clients confirm their relationships, so trust score increases by two.

203 Hewitt adds one large relationship so the relationship value increases by ten.

204 The large relationship is verified through a web source, so trust increases by ten.

205 One small client is added in a ‘hidden’ relationship. The ‘hidden’ option multiplies the relationship value beyond the normal small client value.

206 A client from step 201 denies the claimed relationship. This reduces the relationship by one and the trust score by two (twice the rate of confirmations).

207 One year passes so the trust score increases by ten.

208 Three small organizations add Hewitt Corp to their own relationship records so Hewitt's relationships and trust score increase.

209 A previously confirmed, small client cancels their relationship with Hewitt. The relationship decreases by one but no trust is lost.

Whilst FIG. 13 shows an example implementation, the weighting, rules, and consequences will depend largely on the behaviors expected and veracity required by the system designer. These are expected to change as new behaviors and results are discovered.

### Preserving Anonymity

In certain embodiments, the system employs methods for ensuring that anonymity is indeed preserved by determining whether the attribute data could be used to evince the identity of an organization. For example, a query on suppliers to a given company in a geographic area could return five unidentified suppliers. The sector attribute would indicate four are in the finance sector and one is in nuclear power generation. If there were many finance companies in the area but only one nuclear power station, then the former would remain unidentified and so would be output, whilst the latter would become identified and thus not be output. Therefore, the number of organizations in the database matching the attribute value to be output needs to be greater than the number of third organization matching the attribute value to be output. Otherwise those attribute values will not be output if the set of third organization matching the attribute value to be output includes at least one hidden organization.

The output agent may set a minimum buffer for an attribute count and does not output attributes where the number of matching organizations minus the number of third organizations is the less than this buffer amount. For example, if the buffer is set to three and there are ten organizations to be output (including at least one unidentified organization), each marked as ‘baker’ then the total number of bakers in the database would need to be at least 13 in order to output the count for the business sector attribute. The output or display could still indicate that some third organizations were bakers.

Alternatively the method may set a minimum threshold for an attribute count and not display attributes where the number of organizations in the database with that attribute value is the less than this threshold amount. For example, if the threshold is four and there are only three nuclear power plants in the database then this attribute value will never be displayed.

In a similar scenario, an unidentified organization may become identified by a plurality of combined attribute values being output as a statement, any one of which values would not identify the organization as there are many other organizations with the same single attribute value. However, only one organization in the database matches all of the combined attribute values and is thus identifiable. The same problem exists if any N (e.g. five) organizations are to be displayed (at least one of which is hidden) and there are only N organizations that match the combined attribute values.

The aggregations agent aggregates attribute data of third organizations and selects attribute values (e.g. banks) or combined attribute values (e.g. banks in London) for potential output. The agent determines which these selected values or combined values describe any of the hidden third organizations. The agent searches for all organizations in the database that match the selected attribute values or combined values (that also describe hidden third organizations) to determine the total number of matching organizations. Each selected attribute value or combined attribute values (that also describe hidden third organizations), will only be output if the total number of matching organizations is greater than the number matching third organizations.

The remaining selected attribute values (that do not describe hidden third organizations) are output. Alternative attribute values (or combined values) may be selected to replace the selection blocked from output.

An alternative solution, possibly used in combination with the above solution, is to output an attribute value in more general terms. Thus in certain preferred embodiments there is a taxonomy having hierarchal structure for attributes that describe classes. The above nuclear power generation company could be described as ‘an energy supplier’ to preserve anonymity, assuming there were several such suppliers in the relevant area. A wedding cake maker could be described generally as a ‘baker’ or even more generally as being in the ‘food and drink industry’. Similarly, numerical attributes, such as number of employees or revenue, could be described using progressively wider ranges. A single company could be described as having exactly 82 employees, between 50 and 200 employees or more than 50 employees.

### Conditional Visibility

In certain embodiments, the visibility of a client is conditional, whereby the identity is not revealed to a user unless certain conditions are met. The condition may be that the user's organization's attributes are similar to the attributes of the hidden client. Thus users can see the clients most relevant to themselves but cannot determine all clients of the vendor. The agent may ensure that the user's organization has been identified or verified before revealing hidden clients. This prevents users from accessing clients using false accounts. To prevent ‘gaming’ of the system by buyer-users, the system confirms the identity of the buyer-organization. As discussed above, the system may require the buyer-user to login while the system authenticates that the user is associated with the buyer-organization.

In another embodiment the condition may be that the user significantly interacts with the present system. The interaction may be measured by a tracking agent, using the user's IP, cookies, or account ID to log the length of time spent on the website, number of search queries, depth of URLs requested for the relevant vendor, or communication with the relevant vendor. Thus users investing significant time can see the clients of vendors of interest but cannot view all clients of all vendors. The breadth and depth of the interactions are logged to quantify the user's interaction. Alternatively the interaction requirement may be that the user visits a specific page or performs a specific action, such as visit the vendor's profile page or send a message to the vendor. Interaction greater than a threshold or for a specified action, on the website in general or for a particular vendor, will satisfy the conditions and the client will be made visible for that particular user.

In another embodiment the condition may be that the employees of the buyer have a social network connection with employees of the vendor. This ensures that users are identifiable to the vendor and that a limited number of known people can see a relationship.

In certain embodiments, the algorithm combines requirements for revealing the identity and/or combines similarity scores and interaction scores to determine whether requirements are met. Thus only user's that spend sufficient time on the website will see identities of clients that are sufficiently similar to their own organization. The requirements and scores may be compared quantitatively, such that high similarity may compensate for low interaction.

In certain embodiments, the verification agent enables the vendor-user to suggest via a UI that visibility of one or more clients should be permitted for a particular user or organization. The agent may determine relationships or clients that are relevant to the user's organization or relevant to the user's search query. These are communicated to the vendor-user as a suggestion in order to improve vendor ranking. If the vendor-user permits visibility, the agent updates a data object of permitted users or organizations. The set may be rules-based and/or time-limited.

The conditions for hiding or permitting visibility may be stored with the relationship data object or vendor data object. The set of permitted viewers may be stored in the database with the relationship data object or vendor data object. The structure implemented will depend of whether the administrator intends visibility to be a global or local matter.

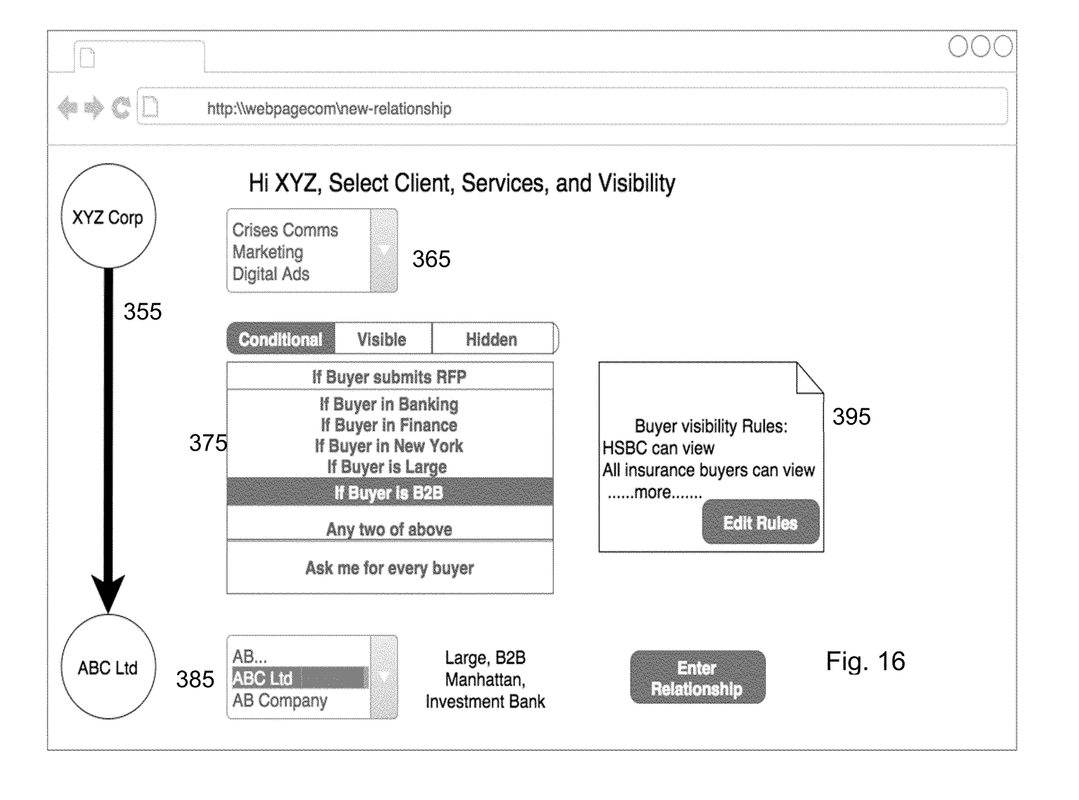

FIG. 16 shows a UI for a server to receive relationship data 355 from vendor XYZ Corp 355 about client ABC Ltd 385 with regard to service 365. The server further receives visibility data 375 indicating whether the client is visible/hidden/or conditionally visible and the attendant conditions. The attributes of the client, known from the database, are used to confirm the correct client has been entered and are used to suggest attributes of future buyers that would satisfy the conditional visibility.

The server adds the relationship and visibility data to the database. This may be added as a new data object, unless the relationship was previously added. The server links the client (second organization) and vendor (first organization) with the relationship data object.

The visibility data may indicate a condition whereby the server should reveal the identity of second organizations to the other users. In response to subsequent search queries by other users associated with third organizations (as buyers), the server will output identification data or aggregated attributed data as discussed above. If the visibility condition is met, the server may include the client's identity in the web content to be output.

If the visibility condition depends on similarity, the server will determine whether the third organization has one or more attributes matching one of more attributes of the second organization. Alternatively the server may determine whether the similarity score (as discussed above) is greater than a threshold.

Certain terms are used herein interchangeably. For example, aspects that are intended to be hidden from output may be called ‘anonymous’, ‘unidentified’, ‘private’ ‘obfuscated’ or ‘hidden’ whereas those intended for output may be called ‘public’, ‘identified’, or ‘visible’.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” between alternatives is to be understood in the inclusive sense, whereby either alternative and both alternatives are contemplated or claimed.

For the sake of convenience, the example embodiments above are described as various interconnected functional agents. This is not necessary, however, and there may be cases where these functional agents are equivalently aggregated into a single logic device, program or operation with unclear boundaries. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A computer-implemented method for verifying data input to a database identifying business relationships between organizations, the method comprising:
receiving data from a user associated with a first organization, the data defining a business relationship between the first organization and a second organization;
storing said relationship data;
selecting and implementing one or more verification schemes;
determining whether the selected verification schemes verified the relationship data; and
updating a relationship confirmation score or status accordingly.

2. The method of claim 1, wherein the steps of selecting and implementing a verification scheme are contingent upon the relationship being selected according to a sampling algorithm.

3. The method of claim 1, further comprising selecting another of the verification schemes if the relationship confirmation score remains below a threshold or the relationship confirmation status remains unverified.

4. The method of claim 1, wherein one of the verification schemes comprises:
communicating, over a network, a verification URL to a second user associated with the second organization, wherein following the URL provides means for the second user to verify the relationship data; and
authenticating whether the verification response originated from a user associated with the second organization.

5. The method of claim 1, wherein one of the verification schemes comprises using a web crawler to search for identity data of first and second organizations in a single web content.

6. The method of claim 5, wherein the web crawler is directed to a website (a) relevant to at least one of said organizations, (b) associated with an industry of at least one of said organizations or (c) selected from a set of authenticated websites.

7. The method of claim 1, wherein one of the verification schemes comprises: communicating with an authenticated third-party database, accessed by the first organization, to verify the relationship data in that third-party database.

8. The method of claim 1, wherein one of the verification schemes comprises providing means for a second user associated with the second organization to log in to an account on the web service and enter their confirmation or rejection of the relationship data.

9. The method of claim 1, wherein one of the verification scheme comprises receiving a URL from the first user and then crawling the webpage at the URL for data confirming the relationship.

10. The method of claim 1, further comprising providing an interface to the first user to mark the second organization as hidden or visible and then setting a status of the relationship as such.

11. The method of claim 1, wherein the selection of verification scheme(s) depends on success of verification schemes previously selected for the first organization.

12. The method of claim 1, wherein the selection of verification scheme(s) depends on a trust score associated with the first user or first organization.

13. The method of claim 1, further comprising initializing the relationship confidence score with a score that depends on a trust score associated with the first user or first organization.

14. The method of claim 1, further comprising increasing a trust score of the first organization, if the relationship data is verified by the selected verification scheme.

15. A computer-implemented method for accessing a database identifying business relationships between organizations, the method comprising:
receiving, at a webserver, a request for certain web content from a client computing device;
querying the database to identify business relationships satisfying said request;
for each identified relationship, retrieving an associated relationship confirmation score or confirmation status, indicating whether the relationship's data has been confirmed;
preparing web content using only relationships associated with a confirmation score above a threshold score or a confirmation status of TRUE; and
serializing and communicating said web content to the client computing device.

16. The method of claim 15, wherein preparing said web content comprises
aggregating the attribute data of client organizations associated with the identified relationships across a plurality of attribute values and
selecting some of the aggregated attribute values, using only relationships associated with a confirmation score above a threshold score or a confirmation status of TRUE.

17. The method of claim 15, wherein preparing said web content comprises computing recommendation metrics for vendor organizations using only relationship associated with a confirmation score above a threshold score or a confirmation status of TRUE.

18. A computer-implemented method comprising:
providing a database of organization objects connected by relationship objects, some of which relationships are unverified; one or more processors receiving a request from a user to send a message to a vendor in the database;
one or more processors retrieving, from the database, attributes of at least one unverified relationship of the vendor;
the one or more processors creating a text statement comprising the attributes of the unverified relationship;
the one or more processors including the text statement in the message;
the one or more processors receiving a response message from the vendor;
the one or more processors analyzing the response message to determine whether the message corroborates the unverified relationship;
and the one or more processors updating a confirmation status or score of the unverified relationship depending on the corroboration.

19. The method of claim 18, wherein the at least one unverified relationship is selected based on relevance of attributes of the relationship or associated client to the user's organization's attributes or to the user's search query

20. The method of claim 18, further comprising determining whether the response includes data that verify the relationship and amending a confirmation status of the relationship in the database accordingly.
